(19) United States
(12) Patent Application Publication
(10) Pub. No.: US 2026/0342100 A1
(43) Pub. Date: Oct. 29, 2026

(54) MULTI-LAYERED DIGITAL TWIN CONSTRUCTION, UTILIZATION, AND ADAPTATION IN COMPLEX SYSTEMS

(71) Applicant: THE UNIVERSITY OF WESTERN ONTARIO, London, Ontario (CA)

(72) Inventors: Pengyi JIA, London, Ontario (CA); Xianbin WANG, London, Ontario (CA); Fang FANG, London, Ontario (CA)

(21) Appl. No.: 19/485,545

(22) PCT Filed: May 17, 2024
(86) PCT No.: PCT/CA2024/000006

§ 371 Date: Nov. 18, 2025

Related U.S. Application Data
(60) Provisional application No. 63/503,266, filed on May 19, 2023.

(51) Int. Cl. H02J 3/38; G06N 20/00; G06Q 10/0639; G06Q 50/06

(52) U.S. Cl. CPC H02J 3/381; G06N 20/00; G06Q 10/06393; G06Q 50/06

(57) ABSTRACT

A method for digital twin construction in a complex system including a plurality of connected objects reporting system data to at least one server, the method including: evaluating the system data reported from the plurality of sensor modules in the plurality of connected objects; determining an insufficient/unsatisfactory performance in the operational objective of the complex system based on comparing the performance to an expected baseline value or range; generating an element digital twin in the lowest layer for detailed digital representation of the connected object; integrating multiple element digital twins to construct a system digital twin in one of the higher layers to evaluate the insufficient/unsatisfactory performance in the operational objective and predict a problematic subsystem responsible for the insufficient/unsatisfactory performance; determining a plurality of relevant connected objects that are relevant to the problematic subsystem and relevant to the operational objective to further guide the formation of element digital twin; integrating elements of the subsystem to form a further subsystem digital twin iteratively, and generating operating decisions to satisfy operational objectives based on the prediction of system digital twins. Systems and non-transitory computer-readable media for executing the method are also described.

### BACKGROUND OF THE INVENTION

### Field of the Invention

The present invention relates to the construction, utilization, and adaption of digital twin in complex systems, and more particularly multi-layered or multi-level digital twins in complex systems.

### Description of the Related Art

The dynamics within a complex system due to varying operating conditions, device mobility, and frequent machine-human interactions make it difficult to directly manage a complex system to meet its operational objectives. As the virtual representation of the connected objects or systems, digital twins are comprehensive models that are expected to achieve desired modeling, behavior analysis, and prediction of the connected objects or systems and can be used to achieve optimized operation for the complex system under highly dynamic system conditions.

One reason for the complexity of using digital twins to support effective management and operation of the complex system is due to overly complex data collection processes for digital twin construction. Collecting system-wide information to build digital twins for the entire system without selection to support system operation using conventional techniques can be highly inefficient. Given a large number of connected objects (e.g., devices/machines) within a complex system, excessive resource consumption during digital twin modeling and lagged response to application demand can make digital twins ineffective.

Another reason for the complexity of using digital twins for managing the complex system is the one-size-fits-all complex system modeling approach. Conventional digital twin modeling methods often involve all connected objects and attributes within the complex system while overlooking the real-time situation of the system. Without fully understanding the operational objectives and current situations of the system, the digital twins established could be inefficient and overly complicated, deteriorating their usefulness in supporting system operation.

Another reason for the complexity of using digital twins to support complex system operation can be an overly complex decision-making process based on the digital twin involved, which could become unsolvable given the systems' computational capacity and limited time. Given a growing size of the system-wide management problem, decision-making in complex systems could generally consist of multiple operational objectives and large number of connected objects, leading to an overly complicated problem that can be extremely difficult to analyze and solve. The use of digital twins can further generate large amounts of data from all established models, while the necessity of the data is usually not considered. Moreover, designing complicated methods to solve these problems can lead to computationally inefficient solutions and significantly delayed decision-making that cannot fulfill the real-time demands given highly dynamic system situations.

Another reason for complexity of using digital twins to manage complex systems is the data heterogeneity inherent to distributed connected objects and various operation platforms in complex systems. Heterogeneous data sampling capabilities and local clocks in complex systems can cause inconsistent data format, quality, sampling rate, and timestamping accuracy during the digital twin modeling and decision-making, which can further degrade effectiveness of system management.

Accordingly, there is a continuing need for alternative approaches enabling digital twin construction, utilization, and adaptation in complex systems.

### SUMMARY OF THE INVENTION

In an aspect there is provided, a method for the construction of scalable, adaptive, and hierarchical multi-layered digital twins for managing and operating complex systems in satisfying their one or more operational objectives, the method comprising:
identifying operational objectives of the complex system involved and collecting system data relevant to the identified operational objectives. The system data includes, but is not limited to, operational parameters, configuration settings, performance indicators, status information, and environmental conditions. These system data are collected from various components of the complex system include, but are not limited to connected objects, servers, and human operators. The system data pertains to the entire complex system, its subsystem, or any connected objects involved in the complex system; and
conducting a rapid system situation evaluation of the complex system by analyzing the collected system data from different parts of the system to identify potential problems of system operation and develop the digital twin construction strategy; and
designing and adapting the hierarchical multi-layered digital twin architecture to be responsive to system situations and operation problems, wherein the digital twin architecture comprises varying numbers of digital twin layers, and each digital twin layer is characterized by different scales, structures, functionalities, inputs, outputs, and modeling processes; and
designing the data gathering, data processing, and digital twin modeling processes to be vertically integrated and dynamically adjusted based on system situations; and
utilizing the multi-layered digital twins to generate decisions and optimize system performance, thereby satisfying one or more operational objectives of the complex systems; and
developing a human-in-the-loop digital twin structure to flexibly integrate autonomous operation and human operator inputs, enabling a range of operation modes including fully autonomous operation, human-guided operation, and integrated hybrid operation; and
continuously monitoring the system conditions by repeating system data collection, system situation evaluation based on the updated data collection, and re-optimizing multi-layered digital twin and the system operation upon identification of system problems to ensure sustained satisfaction of system operational objectives.

In another aspect there is provided, a method to construct multi-layered digital twins in a complex system comprising a plurality of connected objects reporting system data related to operation performance to at least one servers, wherein the multi-layered digital twin architecture comprises:
one or more higher layers to construct system digital twins by integrating and analyzing the system data collected from the complex system in satisfying operational objectives, wherein the system digital twin constitutes the digital representation of the entire complex system or any of its subsystems that provide insights into the overall performance and potential systemic issue; and
one lowest layer to construct element digital twins by collecting, processing, and modeling system data from individual connected object, wherein the element digital twin is the digital representation of at least one attribute of one connected object represents the operational status and performance of the specific connected object. The method to construct multi-layered digital twins further comprising:
collecting system data reflecting the system operational situations reported from the plurality of sensor modules in the plurality of connected objects, preferably in the form of the processed key performance indicator (KPI) data relevant to one or more identified operational objectives of the complex system based on the collected system data from the connected objects; and
establishing system digital twins to model, analyze, predict, and evaluate system situations, and determine instances of insufficient or unsatisfactory performance by comparing the operational outcomes of the system or its subsystems against an expected baseline value or range; and
deciding the number and structure of layers in the multi-layered digital twin architecture based on the situation of the complex system; and
analyzing, determining, and predicting one or more problematic subsystems with insufficient/unsatisfactory performance and determining a plurality of connected objects that are relevant to the problematic subsystem and the attributes of the determined connected objects that are relevant to the operational objective to guide the modeling in the lowest layer; and
processing and modeling system data reported from the determined connected objects to generate an element digital twin of one determined attribute of one determined connected object by analyzing its historical and/or real-time system data, such an element digital twin could be used to generate detailed analysis and predictions of at least one aspect of the future states or conditions of the connected objects; and
integrating a plurality of element digital twins to construct or update the system digital twin for the problematic subsystem to generate system-level insights and operation decisions for further objective accomplishment.

In another aspect there is provided, a computer-implemented method for digital twin construction in a complex system comprising a plurality of sensor modules communicative with a plurality of connected objects communicating with a communication network and reporting system data via the communication network to at least one server, the method comprising: identifying an operational objective of the complex system and a key performance indicator (KPI) associated with the operational objective; obtaining KPI data to measure performance of the complex system in terms of the operational objective, wherein the KPI data is associated with a timestamp and is dynamically obtained based on measured system data reported from the plurality of sensor modules, model-based KPI prediction, or a combination thereof; determining an unsatisfactory performance in the operational objective of the complex system based on a gap between the obtained KPI data to an expected baseline value or range to identify a problematic subsystem; generating a plurality of element digital twins based on measured system data from the plurality of sensor modules, each of the plurality of element digital twins including a model parameter to represent an attribute of at least one of the plurality of connected objects relevant to the identified problematic subsystem, the attribute being measured by at least one of the plurality of sensor modules, each of the plurality of element digital twins generating predicted system data based on the model parameter, the predicted system data associated with a timestamp; integrating the predicted system data, the model parameter, or both the predicted system data and the model parameter of at least a portion of the plurality of element digital twins to construct a system digital twin to receive and evaluate the predicted system data from the at least a portion of the plurality of element digital twins.

In further aspects, systems and non-transitory computer-readable media for executing the method are also provided.

### BRIEF DESCRIPTION OF THE DRAWINGS

FIG. 1 shows a system diagram illustrating the typical architecture of a complex system.

FIG. 2 shows a system diagram illustrating a process of digital twin-based management of the complex system.

FIG. 3 shows a block diagram illustrating a structure of a connected object 101 in the complex system.

FIG. 4 shows a block diagram illustrating another structure of a connected object 101 in the complex system with more interfaces.

FIG. 5 shows a block diagram illustrating the architecture of the multi-layered digital twin consisting of one or more higher layers for system digital twin construction and the lowest layer for element digital twin construction.

FIG. 6 shows a flow diagram illustrating procedures for managing the complex system using multi-layered digital twins.

FIG. 7 shows a flow diagram illustrating a process of the rapid evaluation of the overall system situation by leveraging system digital twins in the higher layers.

FIG. 8 shows a flow diagram illustrating a process of multi-layered digital twin construction including higher layers and the lowest layer.

FIG. 9 shows a flow diagram illustrating a process of pre-model data processing before constructing element digital twins in the lowest layer.

FIG. 10 shows a flow diagram illustrating a process of system-wide decision-making enabled by the multi-layered digital twins.

FIG. 11 shows a network diagram for Experimental Example 1 illustrating an example of the currently disclosed multi-layered digital twin technology for managing a complex heterogeneous network consisting of different base stations and distributed user equipment.

FIG. 12 shows the identification of hotspots in the heterogeneous networks enabled by Layer-I digital twin in Experimental Example 1; the capacity and demand models are separately constructed, based on which the problematic areas can be rapidly obtained; Layer-II digital twins will be formed for all hotspots concurrently; (FIG. 12A) Network capacity modeling. (FIG. 12B) Network demand modeling. (FIG. 12C) Network hotspots (dark areas) identification.

FIG. 13 shows the dual-layered digital twin paradigm with threshold-based UE selection mechanism can enhance QoS satisfaction by filtering non-ideal UEs in Experimental Example 1.

FIG. 14 shows that in a comparison of network resource consumption of various modeled states with different network scales in Experimental Example 1, dual-layered digital twin with intelligent UE selection can achieve the most efficient digital twin modeling.

FIG. 15 shows a system diagram for Experimental Example 2 illustrating an example of the currently disclosed pre-model data processing technology for establishing system digital twins based on the multiple series of system data from distributed connected devices.

FIG. 16 shows that in a comparison of system digital twin modeling of the multiple series of system data from distributed connected devices with and without the data processing technology in Experimental Example 2. The modeling performance by adopting the invented method can be dramatically improved.

FIG. 17 shows a system diagram for Experimental Example 3 illustrating a typical architecture of a complex supply chain system that can adopt the currently disclosed multi-layered digital twin technology for efficient management.

FIG. 18 shows a system diagram for Experimental Example 4 illustrating a typical architecture of a complex smart grid system that can adopt the currently disclosed multi-layered digital twin technology for efficient management.

### DETAILED DESCRIPTION OF PREFERRED EMBODIMENTS

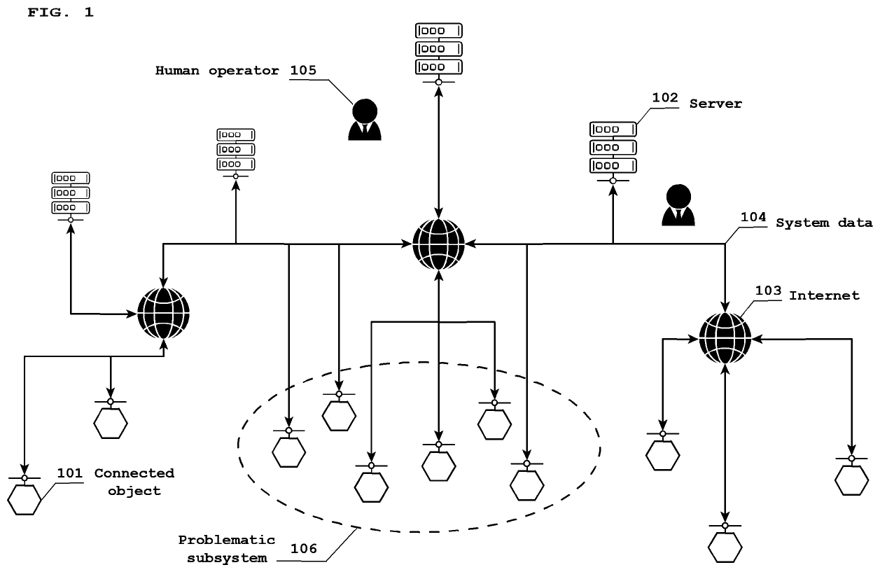

Referring to FIG. 1, the system diagram illustrates an exemplary complex system comprising various components, including connected objects 101, one or more servers 102, and one or more human system operators 105. All the components are interconnected via the Internet 103, facilitating potential collaboration and cooperation. The connected objects 101 are configured to transmit system data 104 relevant to themselves, their subsystems, or the overall complex system to one or more servers 102. One part or aspect of the complex system containing one or more groups of connected objects with non-desired performance is defined as a problematic subsystem 106. Control of the complex system can be centralized in a single server or decentralized across a plurality of servers, depending on the specific system structure. The depicted system architecture in FIG. 1 represents a generalized structure applicable to a wide range of complex systems, such as telecommunication systems, industrial Internet of Things (IOT) systems, intelligent transportation systems, smart grid systems, supply chain systems, environment monitoring systems, and others. An example of such a complex system is an intelligent manufacturing system, where distributed connected objects may include a multitude of sensors and actuators across several production lines. These connected objects continuously generate and report system data measured by sensors to one or more smart gateways or a cloud center for ongoing production monitoring and control. A connected object is a physical and tangible construction that may be any electronic device, apparatus, assembly or machine linked to at least one server via a communication network receiving instruction from the at least one server and may include, for example, computers, smartphones, wearable devices, virtual reality headsets, smart home devices or appliances, autonomous vehicles, networked vehicles, electronic medical devices, smart healthcare devices, and industrial machines. In some examples, a connected object need not be physically coupled or wired to an embedded sensor, and may be communicative with a remote sensor.

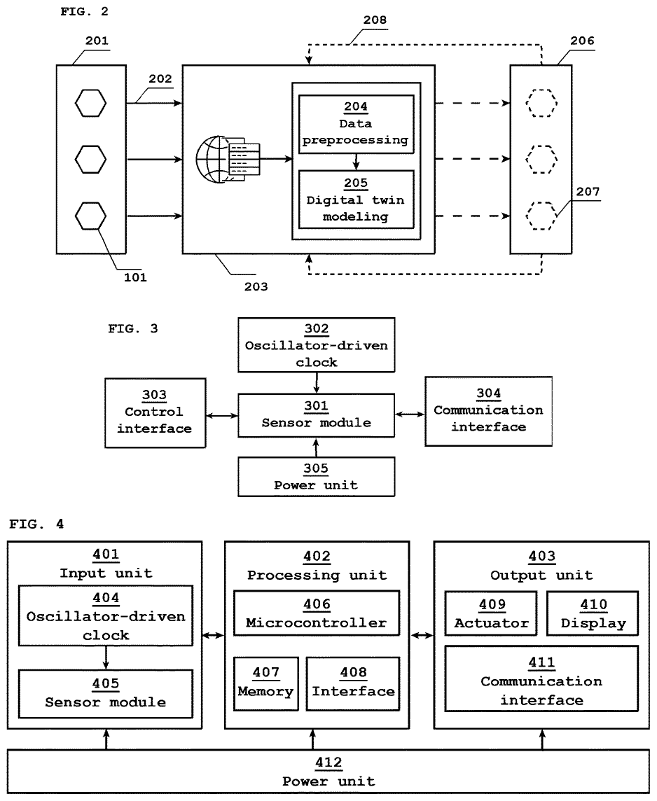

Referring to FIG. 2, the system diagram illustrates an exemplary system management process enabled by digital twins. This process comprises the physical domain 201, which includes a plurality of connected objects 101; the server platform 203, which hosts one or more servers 102; and the digital domain 206, which contains a plurality of digital twins 207 constructed based on the connected objects 101. Specifically, the connected objects 101 upload system data 104 via link 202 to the server platform 203. This system data undergoes preprocessing 204, including steps such as data normalization and cleaning, followed by digital twin modeling 205, where digital representations are structured and optimized. The completed digital twins 207 are designed to generate predictive data, which aids in decision-making 208 at the server platform, thus enhancing the operation of the complex system.

One reason for the complexity of using digital twins 207 to support effective management and operation of the complex systems is the data collection processes 202. Conventional data collection methods in such systems are often routine, nonselective, and lack prioritization, leading to complexities and inefficiencies in constructing digital twins. The practice of collecting comprehensive system-wide information to build digital twins 207 for the entire complex system can be highly inefficient. Additionally, in complex systems populated with a large number of distributed connected objects 101, the excessive consumption of communication resources during the transmission of system data 104 and lagged decision-making process 208 in response to application demands can compromise the effectiveness of digital twins. The nonselective reporting of all attributes associated of all connected objects 101 and the inability to adapt to real-time system situations further increase the complexity of data collection.

Another reason for the complexity of using digital twins 207 for managing the complex system relates to the prevalent one-size-fits-all approach to complex system modeling and updating at server platform 203. This approach often results in high complexity in data preprocessing 204 and digital twin modeling 205 when constructing digital twins of the entire complex system across one or more servers. Conventional digital twin modeling methods typically encompass all connected objects 101 and their associated attributes within the complex system but may overlook the real-time situation of the complex system. The lack of an understanding of the operational objectives and current situations of the complex system means that the digital twins 207 could be inefficient and overly complicated. Such complexities may diminish their effectiveness in supporting system operations, particularly when faced with the limited processing capabilities of the servers.

Another reason for the complexity of using digital twins 207 for managing the complex system stems from the intricacies of the decision-making process 208 based on the digital twins, which could become unresolvable due to the limited computational capacity and constrained timeframes within the complex system. As the system grows, the scope of system-wide management problems also expands, typically encompassing multiple operational objectives and a large array of connected objects. This expansion results in overly complicated management problems that are difficult to analyze and resolve effectively. Moreover, the use of digital twins 207 tends to generate a substantial volume of data, the necessity and utility of which are often insufficiently assessed. The development of complex methods intended to address these multifaceted management problems can inevitably lead to solutions that are computationally inefficient and may significantly delay the decision-making process 208, failing to meet the real-time requirements posed by highly dynamic system situations. Additionally, the absence of efficient mechanisms for updating digital twins post-decision-making further restricts the long-term effectiveness of digital twins in adapting to and managing dynamic complex systems.

Another reason for the complexity of managing complex systems using digital twins arises from the inherent heterogeneity of system data associated with distributed connected objects and various operation platforms. The heterogeneous nature of sampling capabilities and differing qualities of local clocks in these systems can lead to inconsistencies in data format, quality, sampling rate, and timestamping accuracy. Such discrepancies can complicate the digital twin modeling and decision-making processes, potentially undermining the effectiveness of complex system management. Referring to FIG. 3, the block diagram illustrates an exemplary structure of a connected object 101, comprising: a sensor module 301 to measure system data; an oscillator-driven clock 302 to maintain local time; a control interface 303 that can optionally connect to a microcontroller or microprocessor for local data processing; a communication interface 304 to transmit system data to the servers 102 or other connected objects; and a power unit 305 to provide the necessary operational energy. Due to the variations in clock quality, sensing elements, sampling rates, signal conditions, and communication protocols, the system data generated by different connected objects 101 will exhibit heterogeneity in terms of structures, formats, qualities, scales, resolutions, and timestamping accuracy, necessitating specific preprocessing prior to constructing digital twins.

Referring to FIG. 3, the block diagram illustrates another exemplary structure of a connected object 101, comprising: an input unit 401 to generate local information, which includes an oscillator-driven clock 404 to maintain local time and a sensor module 405 to generate local system data; a local processing unit 402 to further process the generated system data, including a microcontroller 406, a memory 407 to store local data, and an interface 408 for interaction with other units; an output unit 403 to further deal with the processed data, including an actuator for executing local control command, a display unit for visualizing information to human operators 105, and a communication interface for transmitting locally generated system data to other connected objects 101 or the servers 102. Given the diversity in clock quality, sensing element, sampling rate, processing capability, size of memory, actuator capability, signal condition, and communication protocol, the system data generated at connected objects 101 will be heterogeneous in terms of structures, formats, qualities, scales, resolutions, and timestamping accuracy, necessitating specific preprocessing prior to constructing digital twins.

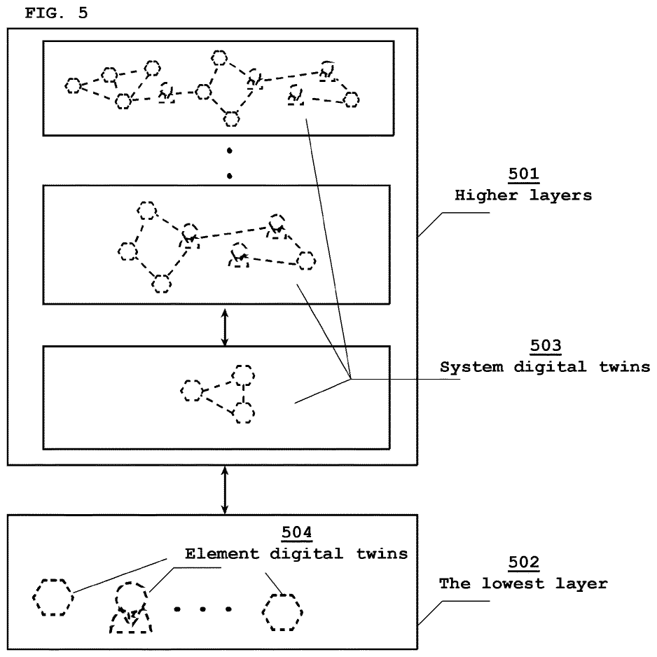

To address the system management complexities, the present disclosure introduces a scalable, adaptive, and multi-layered digital twin construction and update method aimed at simplifying management and operation of complex systems. Referring to FIG. 5, the described multi-layered digital twin architecture consists of one or more higher layers 501 designed to construct one or more system digital twins 503 for the complex system or its subsystems, and the lowest layer 502 to construct a plurality of element digital twins 504, each representing one or more attributes of one connected object 101.

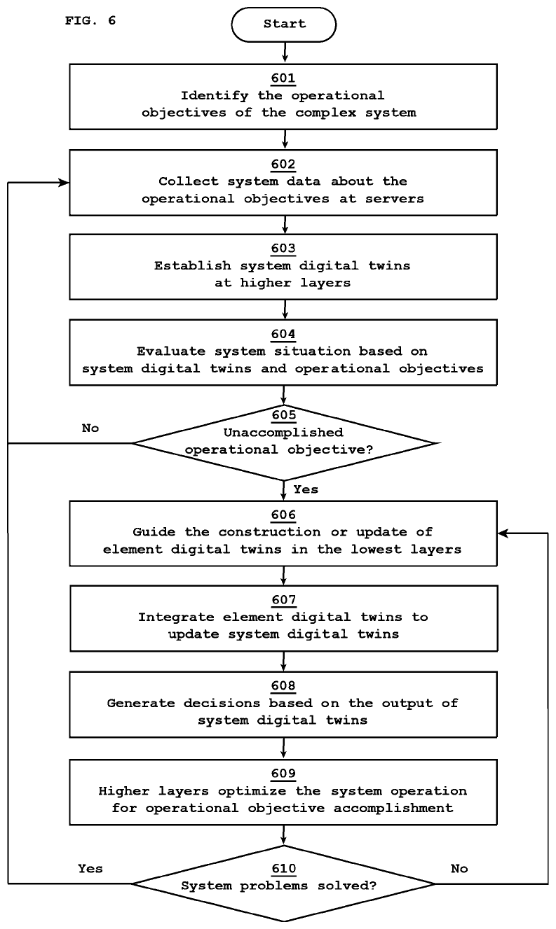

Referring to FIG. 6, the procedures of the disclosed multi-layered digital twin construction and update method are illustrated. In block 601, the operational objectives of the complex system are identified based on the intended functionalities, services, and applications of the system. These operational objectives represent the goals that must be achieved to deliver the designated functionalities, services, and applications of the complex system. Typical operational objectives for complex systems may include, but are not limited to latency, reliability, efficiency, availability, and safety.

In block 602, the servers 102 will collect system data relevant to the identified operational objectives. This system data includes, but is not limited to, system statistics, KPI data, and system log data. KPI data, which are specific and measurable metrics that can be observed, recorded, and predicted, are preferably collected to accurately evaluate the system situation. The determination of which KPI data to collect is informed by previously stored knowledge at the servers 102. Human operators 105 are optionally involved in this process, manually selecting KPIs based on their prior experience during situation evaluation.

An example of an operational objective in a telecommunication system is the network throughput, which is crucial for enhancing user satisfaction and service quality. Corresponding KPIs for this objective might include signal strength, bandwidth utilization, packet loss rate, and connection stability. Relevant connected objects 101, such as routers, switches, base stations, and user equipment, can generate and transmit system data related to these KPIs to enable continuous system monitoring and optimization.

Another example of an operational objective is the efficiency of a complex supply chain system, which directly impacts the cost and speed of operations. Corresponding KPIs could include unit cost, inventory turnover, resource utilization rate, and transportation utilization rate. Relevant connected objects 101, such as RFID tags, GPS trackers, and drones, are employed to generate and transmit system data related to these KPIs, aiding in tracking the system situation.

Another example of an operational objective in a smart grid system is the energy distribution efficiency. Relevant KPIs for this operational objective could include grid reliability, energy loss percentage, and the system average interruption duration index. Connected objects 101 such as smart meters and grid sensors are utilized to generate and transmit system data related to these KPIs, providing useful information to utility companies.

Another example of an operational objective is the system reliability of a complex industrial manufacturing system, with corresponding KPIs including uptime percentage, defective product rate, and production capacity. System data relevant to these KPIs are collected by the servers 102 for system-level observation and situation analysis.

In block 603, the servers construct one or more system digital twins for each operational objective within one or more higher layers. These system digital twins encompass both the complete system and/or its subsystems and their inputs in block 603 are the collected system data, including KPI data, system statistics, and log data, to track the performance of the complex system.

In block 604, the servers rapidly evaluate the system situation using the output of the constructed system digital twins, primarily the KPI data representing the system performance, and the predetermined operational objectives to identify potential system-level problems. In block 605, the servers determine whether all operational objectives have been accomplished. If any operational objective remains unaccomplished, one or more system problems are identified, and the process proceeds to block 606 where element digital twins are constructed or updated in the lowest layer based on guidance from the system digital twins. Each element digital twin provides an accurate and detailed digital representation for one or more attributes of a connected object.

In block 607, one or more system digital twins are updated by integrating a plurality of element digital twins. The updated system digital twins represent a targeted observation of the system problems, facilitating decision-making in block 608. In block 609, the servers implement decisions generated from the system digital twins to operate the complex system. In block 610, the servers assess whether the system problems identified in block 605 have been resolved. If resolved, the servers continue to monitor the situation of the complex system with the updated system digital twins. If unresolved, the servers initiate another cycle of element digital twin modeling and subsequent system digital twin updates to further address the remaining issues.

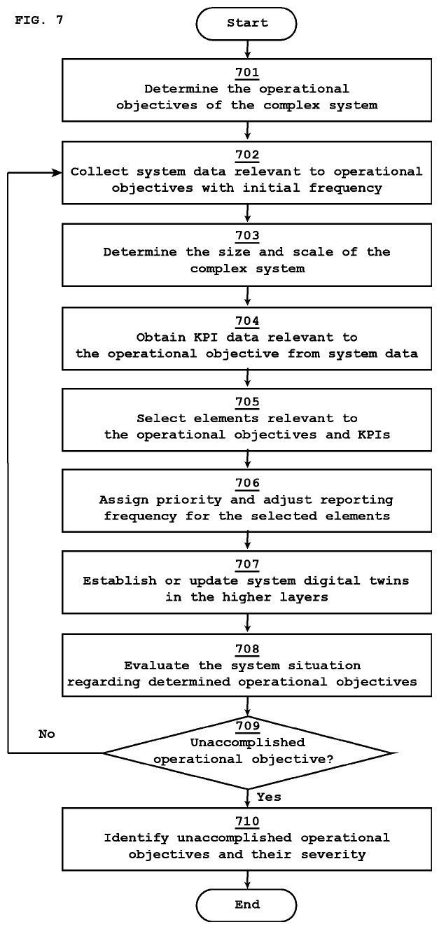

Referring to FIG. 7, the flow diagram illustrates detailed procedures for evaluating the situation of the complex system, identifying potential problems enabled by system digital twins in higher layers through system-level analysis and modeling of system data. In block 701, the operational objectives of the complex system are determined based on the intended system applications, services, and functionalities. In block 702, the servers 102 continuously receive system data routinely reported from the distributed connected objects 101 at an initial frequency to monitor the system behavior. In block 703, the size and scale of the problem to be addressed is determined, based primarily on the relationships among the system data collected from connected objects, the capabilities of the servers, and/or the interests of the stakeholders involved. In block 704, KPIs relevant to each operational objective are obtained from the system data to measure the satisfaction of the complex system regarding the operational objectives.

Following this, in block 705, elements, including connected objects and their attributes closely related to these identified operational objectives and KPIs, are determined and selected to target the system situation evaluation. This selectivity significantly reduces the complexity induced by the massive data collection processes, focusing on essential system data. An exemplary attribute selection method involves analyzing the modeling value through cost-benefit analysis, prioritizing system data that offers high predictive value related to the application. Moreover, based on the previously recorded system data uploaded from connected objects 101, the servers 102 can selectively collect system data from connected objects with previous relevancy. An attribute is a measurable characteristic of a connected object, and the attribute is measured by a sensor; mapping of attribute to sensor may be one-to-one, many-to-one, one-to many.

In block 706, servers assign higher priority to the selected connected objects and relevant attributes. Elements with higher priority will report to the servers with increased frequency and quality, while lower-priority elements will report less frequently. This prioritization ensures that limited communication resources and server processing capabilities are allocated efficiently, focusing on system data needed for meeting operational objectives.

In block 707, the servers 102 construct a system digital twin or update a previously established system digital twin for the entire complex system, utilizing system data to represent the system situation concerning the operational objectives. This system data includes, but is not limited to, system statistics, KPI data, and system log data. Same as block 603, this system digital twin construction or update can be conducted through various data processing techniques or commercialized simulation platforms.

In block 708, the servers evaluate the overall system situation based on the KPI data generated from the system digital twins. This KPI data may be derived from system data predictions made by system digital twins, previously collected KPI data, or a combination thereof. An evaluation of the complex system is generated by comparing the operational objectives with the KPI data. For each specific operational objective, the servers 102 determine a baseline or a certain range for the KPI as the objective threshold. The overall situation of the complex system is then assessed by comparing the system KPI data against this objective threshold. An exemplary method of KPI data analysis involves extracting statistical information from the time-series KPI data continuously generated from the system digital twin, including metrics such as mean, median, and standard deviation, which highlight significant features of the KPI data and facilitate a comparison to the objective threshold.

Based on the analysis results obtained in block 708, in block 709, the servers determine whether all the operational objectives are accomplished. If all objectives are met, the servers revert to block 701 to continue monitoring the system situation by collecting system data from all connected objects 101 with restored priority levels. If any operational objectives are not met, it becomes necessary to further construct digital twins to manage the complex system. In this scenario, in block 710, the servers 102 identify the unaccomplished operational objectives and the corresponding severity of the problems, which guide the construction of element digital twins in the lowest layer. This scalable and adaptive digital twin construction strategy involves continuously estimating the dynamic complex system based on the operational objectives and determining the necessary perspectives to focus on. Given the time-varying situations of the system and the heterogeneous processing capabilities of the servers, the aspects required to be modeled during the digital twin construction can be flexibly adjusted to manage the complexity involved.

Aiming at directly accomplishing the operational objectives of the complex system and to address the problems identified through situation evaluation in block 709, additional digital twin layers are constructed to simplify the data collection and problem-solving processes through a situation-aware problem decomposition approach. Each layer of the digital twin is specifically designed for a distinct purpose.

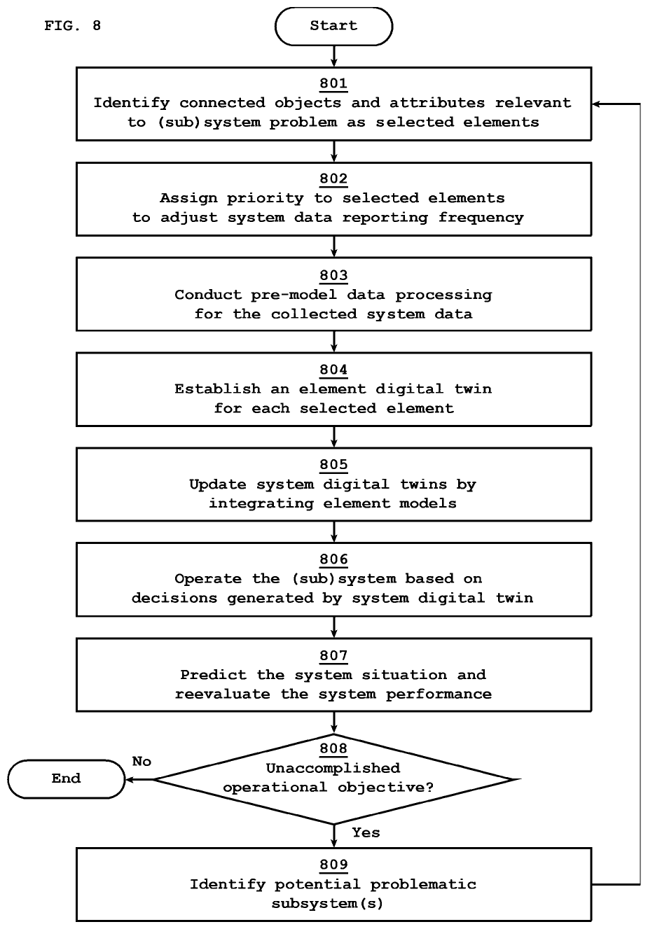

Referring to FIG. 8, the flow diagram illustrates the subsequent procedures for digital twin construction and updates, which include forming an element digital twin for detailed representation of one or more attributes of a connected object, and a system digital twin for the entire system or a subsystem. This is achieved by combining a plurality of element digital twins, facilitating rapid analysis of system situations and problem-centered decision-making on system operation.

In block 801, relevant connected objects and their relevant attributes are identified for addressing the system or subsystem problems, defined as selected elements. An example of system problem identification involves using the system digital twin from block 709 to pinpoint unaccomplished operational objectives. Another example is to analyze the system digital twin constructed in block 807 to generate predicted KPI data, assessing the performance of the complex system or its subsystems. Various connected objects 101, such as devices, machines, and human operators expected to contribute to achieving the operational objective, are initially selected. Subsequently, attributes of these connected objects that are pertinent to the operational objectives are summarized. The servers 102 then evaluate the importance of these attributes in satisfying the operational objectives, categorizing them into levels such as essential, influential, or insignificant based on their significance.

An example of attributes associated with connected objects that are relevant to the productivity of a complex industrial manufacturing system includes output rate, energy consumption, and ambient temperature. The output rate, a useful metric for measuring productivity, reflects the quantity of product that the system can produce over a specific period. Areas with a low output rate may represent bottlenecks that limit the overall productivity of the manufacturing system. Conversely, energy consumption is an influential metric that indirectly impacts productivity; reducing energy consumption can decrease operating costs and thereby enhance the overall profitability of the system. On the other hand, ambient temperature may be considered an insignificant attribute that does not substantially affect productivity and, therefore, should not be prioritized in the analysis of this operational objective.

Another example involves attributes relevant to the throughput of a complex telecommunication system, including achievable data rate, user experience, and the physical size of the communication device. The achievable data rate directly influences the amount of data that can be transmitted over a period and is closely related to network throughput. In contrast, while user experience may improve the efficiency and satisfaction within the communication system, it is not directly related to network throughput. Therefore, enhancing user experience might be considered after addressing more critical issues such as data rate, bandwidth, and interference. Lastly, the physical size of a communication device, although potentially influencing the device's transmission power and hence network throughput, is generally less relevant. Thus, attributes related to the physical dimensions of the device should not be a focus during the throughput analysis of the complex communication system.

In block 802, priority assignment strategies are developed for the selected elements regarding the involved attributes. Essential attributes, which are fundamental to gaining a basic and necessary understanding of the complex system in relation to the specific operational objective, are always selected with the highest priority. Influential attributes, which may affect system understanding or operation to a lesser extent, are optionally selected with a lower priority, depending on the processing capabilities of the servers 102 and the requirements of the intended system functionalities, services, and applications. The modeling cost, influenced by factors including but not limited to data volume, seasonality, stationarity, and variability, is also considered during the selection and priority assignment of influential attributes. Insignificant attributes are assigned the lowest priority to reduce the complexity during digital twin modeling and are typically excluded from digital twin construction. Optionally, human operators 105 can influence the priority assignment by manually adjusting the priority of specific attributes based on their prior knowledge and experience.

Corresponding to the assigned priorities, the data sampling resolution and reporting frequency are further adjusted. Selected elements with higher priorities are permitted to report more frequently and provide higher-quality data to the servers 102, whereas those with lower priorities receive fewer resources, resulting in reduced frequency of data reporting. As a direct result, the overall complexity of data collection and processing across all connected objects 101 in the complex system is managed by flexibly adjusting the priority assignments based on the system or subsystem-specific problems. This strategy enables effective control of the processing difficulty and significantly mitigates excessive response times, ensuring efficient data collection and processing.

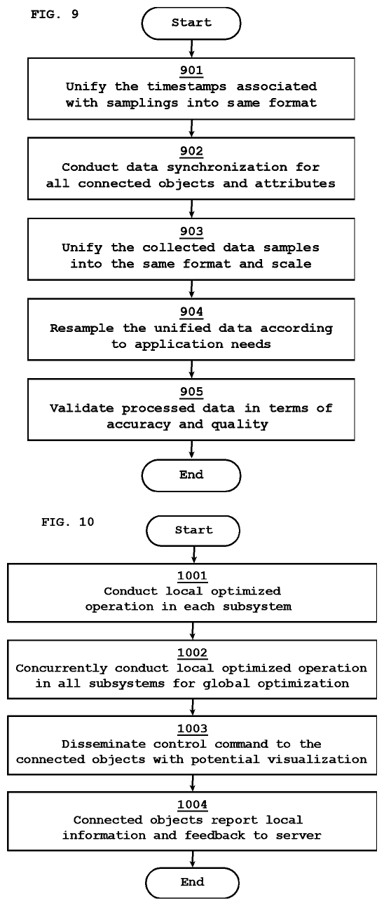

In block 803, pre-model data processing is performed by the servers 102 to enhance the consistency of the collected system data. Various data processing techniques are applied depending on the characteristics of the system data collected from connected objects. Techniques such as data unification, resampling, and synchronization are employed to improve data quality and increase the accuracy of digital twin modeling. This approach reduces the data processing complexity at each server by addressing the inconsistency in system data generated from heterogeneous connected objects and various operational platforms. A detailed flow diagram of the data processing procedures is illustrated in FIG. 9.

In block 804, a plurality of element digital twins are established, each focusing on an attribute of one connected object. The primary function of these element digital twins is to digitally represent the behavior of an attribute of the connected object. Inputs to the element digital twins include system data from the connected objects and guidance from system digital twins, while the outputs include the model parameters of the element digital twins that reflect the future behavior of the elements related to one operational objective. The model parameters of these element digital twins, such as machine learning model coefficients, regression coefficients, hyperparameters, material properties, weighting coefficients, environmental factors, feedback control gains, threshold values for anomaly detection, structural integrity metrics, reliability coefficients, energy consumption rates, traffic flow rates, resource allocation weights, connectivity metrics, network topology descriptors, clustering centroids, user behavior patterns, data compression ratios, and packet loss rate, are variables within a mathematical model, statistical model, or computational model (including for example a machine learning model), that define the specific characteristics and behavior of the element digital twins.

The element digital twins in the disclosed method can be constructed by processing the system data using various data processing techniques such as artificial intelligence (AI), time-series data prediction, machine learning algorithms, and statistical analysis, with various programming languages and software environments including but not limited to MATLAB, R, and Python. Taking MATLAB as an example, the Data Processing Toolbox can be used for data preprocessing and cleaning to provide relevant functions for handling missing data, smoothing, and filtering signals, ensuring the data is ready for analysis. The Time-Series Analysis Toolbox is particularly useful for modeling and predicting time-dependent behaviors, which is useful for accurate element digital twin constructions. Moreover, the Statistical and Machine Learning Toolbox of MATLAB enables detailed statistical analysis and hypothesis testing to understand relationships and dependencies in the data. In addition, MATLAB Deep Learning Toolbox can be employed to develop and implement AI models that enhance the predictive accuracy and intelligence of element digital twins, which offers a variety of deep learning algorithms and pre-trained models that can be customized for specific data analysis needs. Further details for constructing a digital twin using these techniques may be found in published literature, including for example: [i] P. Jia and X. Wang, “A new virtual network topology based digital twin for spatial-temporal load-balanced user association in 6G HetNets,” IEEE J. Sel. Areas Commun., vol. 41, no. 10, pp. 3080-3094, 2023; [ii] F. Tao et al., “Digital twin modeling,” Journal of Manufacturing Systems, vol. 64, pp. 372-389, 2022; and [iii] P. Jia, X. Wang, and X. Shen, “Accurate and efficient digital twin construction using concurrent end-to-end synchronization and multi-attribute data resampling,” IEEE Internet Things J., vol. 10, no. 6, pp. 4857-4870, 2023.

As an example, AI techniques, including machine learning and neural networks, enhance the accuracy and capabilities of the element digital twins by utilizing vast datasets to predict future behaviors of the represented connected objects. For example, different AI techniques can be employed based on the specific needs of the modeling. Supervised learning may be used to model and predict specific attributes using historical system data, such as applying regression models or neural networks to forecast the future behavior of a communication device under varying network conditions. These machine learning models are trained on time-series system data collected from the connected objects such as user equipment and network components, enabling the element digital twins to capture complex patterns and dependencies. Alternatively, unsupervised learning methods like clustering algorithms can identify underlying structures or groupings in the system data that influence the behavior of the connected object, which is especially useful for recognizing distinct operational states or conditions of a connected object that are not explicitly labeled during the construction of the element digital twin.

In block 805, one or more system digital twins are established or updated by integrating the model parameters or outputs from a plurality of element digital twins, based on the functional or physical interconnections among connected objects. The integration method disclosed herein encompasses several potential methodologies for defining interactions among element digital twins to construct a system digital twin. These methodologies include, but are not limited to, correlation analysis, causality inference, and reinforcement learning. For example, correlation analysis is used to detect and quantify statistical links between operational parameters across the element digital twins, identifying potential interactions. Causality inference is utilized to determine the directional influence among these model parameters, mapping the flow of effects within the integrated system. Reinforcement learning is applied to dynamically refine and optimize the integration process based on continuous operational feedback, thereby enhancing the adaptability and efficiency of the system digital twin. The choice of integration method may vary depending on the processing capabilities of the servers and the characteristics of the complex system to ensure efficient construction of the system digital twin. The use of causal analysis in analyzing the relationship among data and parameters are publically available, including for example: [i] L. Jakovljevic et al., “Towards building a digital twin of complex system using causal modelling,” in COMPLEX NETWORKS 2021, 2022, pp. 475-486; and [ii] L. Yao et al., “A survey on causal inference,” ACM Transactions on Knowledge Discovery from Data (TKDD), vol. 15, no. 5, pp. 1-46, 2021.

Moreover, some commercially available simulation platforms for digital twins, like Simcenter, ThingWorx, and Azure Digital Twins, can also be used to construct the system digital twins. Detailed utilization procedures and some comparative studies of these platforms can be found, for example, in: [i] F. Rückert et al., “Digital Twin Development: An Introduction to Simcenter Amesim,” Springer Nature, 2023; [ii] D. Adamenko, S. Kunnen, and A. Nagarajah, “Comparative analysis of platforms for designing a digital twin,” in DSMIE-2020, 2020, pp. 3-12; and [iii] S. V. Nath, P. Van Schalkwyk, and D. Isaacs, “Building Industrial Digital Twins: Design, develop, and deploy digital twin solutions for real-world industries using Azure Digital Twins,” Packt Publishing Ltd, 2021.

These techniques and platforms analyze the collected system data and the outputs of element digital twins to track and optimize the performance of the complex system. This process is adaptable to various software solutions known in the art.

The primary function of the system digital twin is to diagnose the system situation, identify potential problems, and make critical decisions regarding system operation. Inputs to the system digital twin include model parameters generated from relatively lower layers and various external relevant data, such as market trends, weather conditions, and consumer behavior data. Outputs from the system digital twin include KPI data, guidance for subsequent modeling of the lowest layer, and decisions on system operation. Additionally, the system digital twins are adaptive to real-time system situations, thereby effectively supporting ongoing system operations.

In block 806, based on the system data predicted by the system digital twin, the server will make decisions aimed at operating the corresponding system to fulfill the operational objectives. Following the implementation of decisions derived from the system digital twin, the system situation is reevaluated in block 807, where an improvement in system performance is typically expected.

In block 808, the accomplishment of the operational objectives is assessed. If one or more operational objectives remain unaccomplished, the servers identify one or more problematic subsystems 106 in block 809. These problematic subsystems, defined as one or more groups of connected objects 101 with one or more unaccomplished operational objectives, act as performance bottlenecks within the complex system and require careful management to accomplish the corresponding system objectives. For example, a problematic subsystem could be an assembly line within a complex manufacturing system exhibiting a low output rate, where all related sensors, actuators, and controllers are deemed critical connected objects needing careful management. By identifying all problematic subsystems, the overall problem in the complex system is decomposed into a plurality of subproblems that can be addressed more effectively.

Following this identification, the servers return to block 801 to re-determine the elements with further priority assignment and report frequency adjustment needed. Element digital twins are then utilized to model these selected elements, providing deeper insights into the problems when integrated into further system digital twins for subsequent decision-making and system operation.

This process illustrates how the multi-layered digital twins are iteratively constructed, employing system digital twins for continuous system evaluation, prediction, and decision-making, and incrementally enhancing the granularity and focus of element digital twins for detailed modeling. Consequently, the overall modeling complexity is effectively managed and reduced through problem-centered analysis and operation.

Referring to FIG. 9, the flow diagram illustrates a series of potential pre-model data processing procedures, including timestamp unification, data synchronization, data unification, data resampling, and data validation. It is important to note that not all these procedures are necessary before digital twin construction, and additional data processing techniques not listed may also be implemented to enhance data accuracy. Preferably, data processing should be conducted prior to the construction of element digital twins, where higher granularity is expected to establish a detailed digital representation for each selected element.

In block 901, the series of timestamps generated by different local clocks 301 embedded in distributed connected objects 101 are unified into a standard format to enable successive timestamp comparison, computation, and prediction. Initially, the servers identify an expected format, such as ISO 8601 or FILETIME, based on system requirements or the majority of local clocks. Subsequently, timestamps in non-standard formats are converted into the chosen format using programming techniques like various string manipulation functions. Once converted, all timestamps are stored at the servers for further processing.

In block 902, the unified timestamps are compared to the time information generated by the servers to achieve time synchronization among the distributed system data. System data collected from different connected objects often show inconsistencies in the temporal domain due to the inaccuracies of local clocks 302, which may produce drifted time information compared to the standard time due to varying frequencies of the local crystal oscillators. To align all system data used for digital twin modeling in the time domain, discrepancies in timestamps are estimated and compensated to ensure data accuracy. System data with higher resolution benefits significantly from more accurate time synchronization. By adjusting for timestamp errors in the data samples, the collected system data are synchronized for subsequent processing. Optionally, a digital twin of the local clocks can be established at the servers based on the unified timestamps to continuously monitor the time information of different connected objects. This model is beneficial for predicting future time errors associated with the local samples when newly generated system data is required.

In block 903, synchronized data are unified at the servers using various data unification techniques such as data normalization, data federation, and data standardization. These techniques ensure that all system data conform to the same format and scale, facilitating consistent and accurate digital twin modeling. In block 904, the unified data are further resampled to a desired sampling rate through techniques like data interpolation and data extrapolation. This adjustment aligns the distributed data frequency with the application requirements. The processes of data unification and data resampling significantly alleviate the complexity of data handling within the servers, enhancing the accuracy of digital twin modeling.

Finally, in block 905, the processed data are validated to ensure their reliability for use in digital twin modeling. Validation checks may include assessing data quality, consistency, resolution, accuracy, and relevant attributes. With the substantially improved data quality and consistency, the validated data are then used by the servers to form more detailed element digital twins. Additionally, based on the assigned priority to different elements, the processing precision is adjusted accordingly. This ensures that only system data deemed essential for modeling are allocated more resources, thereby optimizing the use of computational capacity.

Furthermore, the complexity of data preprocessing is managed by selectively applying data synchronization and resampling procedures at varying granularities across different digital twin layers or modeling iterations. This selective approach allows for the establishment of digital twins with tailored resolutions, based on the specific needs and priorities of the system. By focusing processing efforts only on relevant connected objects and attributes, unnecessary data processing is minimized, enhancing the efficiency and effectiveness of the multi-layered digital twin infrastructure.

Referring to FIG. 10, the flow diagram illustrates system-wide decision-making enabled by the predictive information provided by multi-layered digital twins, where the accurate and efficient management of the entire complex system is progressively achieved by concurrently solving all decomposed sub-problems for identified problematic subsystems 106. This allows for obtaining a globally optimized solution to the overall system-wide problem with dramatically reduced complexity.

Specifically, in block 1001, the local optimization of each identified subsystem relative to its specific operational objective is achieved using appropriate mathematical techniques such as optimization algorithms, control theory, graph theory, and machine learning, all based on the predicted system data obtained from the corresponding system digital twin. As a result, for each sub-problem, given the reduced number of involved connected objects and attributes within the subsystem, its operation can be efficiently optimized with reduced time complexity and computational resources, thereby accurately solving the identified problems to accomplish the operational objectives.

In block 1002, all sub-problems are concurrently solved using the locally optimized solutions derived from the predicted system data of their corresponding system digital twins. Consequently, an optimized global operation of the complex system is efficiently achieved by concurrently addressing all decomposed sub-problems. Necessary control commands generated from these solutions are then disseminated back to all connected objects 101 in block 1003 to operate the complex system effectively.

Meanwhile, the system information including the accomplishment of the operational objectives, tractable metrics like KPI, and various system performance attributes are visualized to provide straightforward feedback to human operators. This human-in-the-loop interface, active during stage such as block 701 during the determination of operational objectives, block 704 for KPI selection, and block 802 for priority assignment, facilitates flexible interaction and manual control over the system operation.

Finally, in block 1004, newly generated system data following system management are continuously uploaded to the servers for ongoing monitoring and potential adaptation of digital twins to the new system situations, as detailed in block 702. This enables further interactive digital twin construction and system operation, ensuring that the system remains responsive and adaptive to the operational changes.

The presently disclosed system and method for digital twin construction and updating in complex systems achieves an objective of reducing operational complexity of digital twin implementation in a complex system, and in optimized examples the reduction of operational complexity can be to such an extent that real-time or near-real-time decision-making can be supported. Reasons for operational complexity in conventional approaches of digital twin implementation in a complex system include the routine, nonselective, and unprioritized data gathering processes for system modeling, the ignorance of heterogeneity within a complex system during system modeling, and the inefficient decision-making in complex systems with multiple operational objectives and massive connected objects.

Enabled by a situation-aware multi-layered digital twin model, the presently disclosed system and method can efficiently evaluate the real-time situations of complex systems, quickly identify significant problems limiting the overall system performance, rapidly respond to system situations, and generate accurate solutions to address the corresponding issues.

During the digital twin modeling process, scalable, adaptive, and hierarchical multi-layered digital twins are established and updated at the servers based on the operational objective driven construction strategy. With this hierarchical multi-layered digital twin architecture, the complex system can be evaluated, predicted, and operated with enhanced efficiency. Specifically, the overall situation of the complex system is rapidly evaluated in at least one server by gathering both newly reported and historically collected system data like system statistics and KPI data from the connected objects according to the operational objectives of the intended system functionalities, services, and applications. A system digital twin will be established to provide an overall insight into the system situation, based on which further digital twin construction strategy will be developed.

Element digital twins are established for attributes of the connected objects relevant to unaccomplished operational objectives, providing detailed insight into their future behavior. Then, system digital twins are updated by integrating a plurality of element digital twins, which can further identify problematic subsystems, thus decomposing the overall operation of the complex system into a number of sub-problems for complexity-reduced analysis and decision-making.

Moreover, the architecture and the corresponding modeling process of the hierarchical multi-layered digital twin is adaptive to the real-time system situation and demands. The number of layers, as well as the scope, scale, and structure of each layer are different from each other. An integrated data gathering and processing framework is designed for each digital twin modeling process and adaptive to the system situation to achieve the operational objectives of the complex system.

Based on the established multi-layered digital twins, optimized decision-makings for operating the complex system are made, comprising the local optimized operation of each identified problematic subsystem and the concurrent optimization of all identified subsystems for global system management with the potential involvement of human operator inputs. Once the problems are solved, newly generated system data will be reported to the servers to update the system digital twin for continuous system situation monitoring, analysis, decision-making, and controlling.

Additionally, according to the real-time requirements and system operational objectives, system situation evaluation and digital twin construction are correspondingly updated to efficiently satisfy the time-varying operational objectives within the complex system. Historical knowledge of system management can be utilized to better guide efficient system operation.

The currently disclosed system and method for digital twin construction in complex systems has been validated by experimental testing. Experimental testing results demonstrate the ability of the currently disclosed system and method to reduce complexity in operating complex systems. The following experimental examples are for illustration purposes only and are not intended to be a limiting description.

### EXPERIMENTAL EXEMPLIFICATION: EXPERIMENTAL EXAMPLE 1 (MANAGEMENT OF USER ASSOCIATION WITHIN COMPLEX HETEROGENEOUS COMMUNICATION NETWORKS ENABLED BY DUAL-LAYERED DIGITAL TWIN CONSTRUCTION)

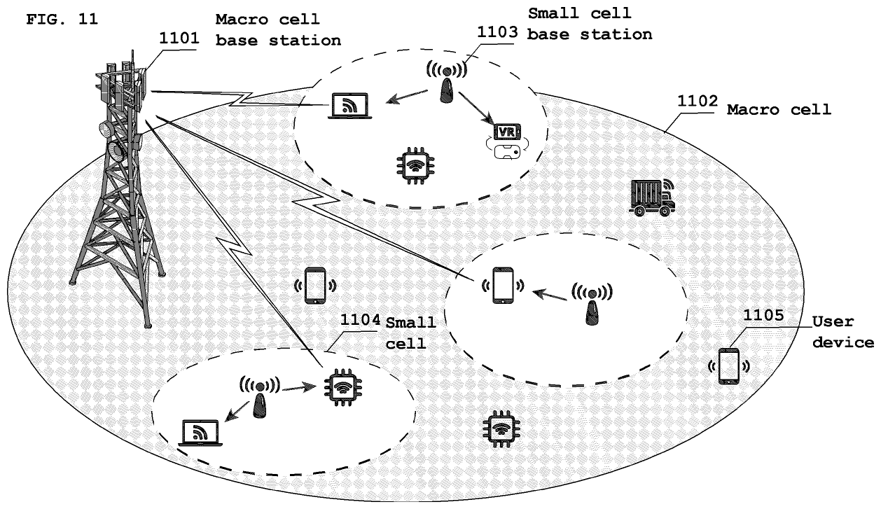

Referring to FIG. 11, the complex heterogeneous networks (HetNets) are considered a complex system, typically consisting of a plurality of connected objects, including various user equipment (UE) 1105 with different types and capabilities, including smartphones, tablets, computers, VR headsets, connected cars, wearables, smart TVs, and connected appliances. These connected objects can report system data with different attributes about the HetNet directly through their built-in capabilities or via additional sensors integrated into the network, such as environmental sensors, power meters, traffic analyzers, latency trackers, packet loss detectors, and performance monitoring tools. The system data from the HetNet might include historical data traffic, user association factors, signal strength measurements, QoS metrics, and network congestion levels. Servers including a macro cell base station (BS) 1101 with strong transmission power and large coverage range for the macro cell 1102, as well as a few small cell BSs 1103 opportunistically deployed to provide enhanced connectivity to different kinds of user equipment (UE) 1105 within the corresponding small cells 1104. The BSs 1102 and 1103, serving as servers 103 in the disclosed invention, provide the processing capabilities necessary to process the system data from the HetNets and establish digital twins for different UEs. Such HetNets are typically highly dynamic due to fluctuating user demands, mobility, and varying network conditions. Using digital twins to achieve optimal connectivity, load balancing, and QoS management is a feasible approach by predicting the dynamics within the complex HetNet and forecasting situations of adopting different management strategies.

However, the use of digital twins for managing the complex HetNet is challenging due to three aspects. First, the complex data collection process due to the routine, non-selective, and unprioritized data gathering from heterogeneous connected objects like smartphones, computers, and VR headsets. Collecting all available system data from all connected objects could consume excessive resources. Meanwhile, the schedule of data upload from distributed connected objects will become overly complex, deteriorating the management efficiency of the HetNets. Second, the complex data processing, as well as digital twin modeling and updating due to the centralized processing of massive, multi-attribute, multi-source, and temporally inconsistent system data from all connected objects, can make the digital twin establishment inefficient, inaccurate, and/or outdated. Third, the finally formed optimization problem, which consists of a large number of connected objects and their associated attributes, will become overly complex and difficult, if not impossible, to solve with traditional mathematical techniques.

The utilization of the presently disclosed system and method for the construction of multi-layered digital twins in a complex system can help achieve low-complexity management of the HetNets. The management process begins by identifying the operational objectives of the HetNets. The operational objectives in such a system might include optimizing overall network performance by enhancing connectivity, balancing load, and improving QoS for UEs. Then, a series of steps to evaluate the system situation is conducted by analyzing the collected system data from different parts of the HetNets. Specific elements from the selected connected objects relevant to these operational objectives are prioritized for data collection, where an element is defined as one attribute of the corresponding connected object.

The BSs continuously monitor the complex HetNets by collecting system data from these prioritized elements. This collected system data is processed to obtain KPI data, which represent the operational situations of the overall complex system or its subsystems. Relevant KPIs for the operational objectives in such a system might include network throughput, latency, packet loss rate, user satisfaction level, and BS traffic loads. The KPI data are dynamically obtained by methods such as analyzing system statistics, collecting reported KPI data, and model-based KPI prediction. By comparing the KPI data with the operational objectives, potential problematic subsystems are identified. For example, by comparing the current network throughput and the application requirements, a gap indicating potential areas of congestion can be identified. Other gaps, including poor signal quality, high latency, or low user satisfaction, are all potential problems in the complex HetNets needing efficient management strategies.

Upon identifying these problematic subsystems, the severity of unaccomplished or unsatisfied operational objectives is reported for further operation and optimization. Based on this evaluation, the multi-layered digital twin construction strategy is developed, prioritizing the creation of digital twins for problematic subsystems with severe problems. If the BSs identify that all operational objectives have been accomplished, they continue to monitor the complex HetNets by collecting system data from the connected objects. This continuous monitoring process ensures that the system can dynamically re-optimize the multi-layered digital twin architecture and operate the overall HetNets upon identifying new problems, thereby sustaining the satisfaction of the operational objectives of the complex HetNets.

With one or more unaccomplished operational objectives identified, the hierarchical multi-layered digital twin architecture is designed and adapted to be responsive to system situations and operational problems. The multi-layered digital twin architecture comprises one or more higher layers for system digital twins configured to model and manage one or more operational objectives of the system or subsystems, and one lowest layer constructing element digital twins or collecting system data from the connected objects based on guidance received from the higher layers, where each element digital twin represents the behavior of its respective connected object. Each digital twin layer is characterized by different scales, structures, functionalities, inputs, outputs, and modeling processes.

In the context of managing the HetNets using multi-layered digital twins, the functionalities of the higher layers include continuously evaluating the system situation, identifying problems such as connectivity issues or traffic congestion, analyzing the root causes of these problems, and making decisions for the operation of the system or subsystems. The lowest layer processes system data and conducts specific modeling for each selected connected object, like a UE identified by the higher layers.

The interactions between the layers of the multi-layered digital twin architecture in the HetNet are characterized by the lowest layer transmitting parameters of each element digital twin to the higher layers, such as traffic load and QoS metrics. A higher layer transmits parameters of its subsystem digital twin, such as regional connectivity distributions, to even higher layers. A higher layer with a system digital twin transmits modeling guidance and operation commands for one subsystem, such as a small cell BS, to another higher layer with the subsystem. A higher layer with a subsystem digital twin transmits modeling guidance and operation commands for the connected objects to guide the lowest layer, ensuring optimized operations across the entire HetNets.

The data gathering, data processing, and digital twin modeling processes are designed to be vertically integrated and dynamically adjusted based on system situations. System data from connected objects is processed at the BSs to establish element digital twins, which model specific elements such as traffic load and signal quality of individual UEs. These element digital twins feed into the higher layers of the system digital twin, which evaluates the overall performance of the HetNet and identifies areas needing optimization.

The multi-layered digital twins are utilized to generate decisions and optimize system performance, thereby actively satisfying the operational objectives of the HetNet. This includes dynamically adjusting UE associations, BS load distributions, and network configurations to enhance connectivity, balance traffic, and improve QoS. Additionally, a human-in-the-loop digital twin structure can be developed to flexibly integrate autonomous operations and inputs from human operators. This structure enables a range of operation modes, including fully autonomous operation, human-guided operation, and integrated hybrid operation.

The system conditions are continuously monitored by repeating the system data collection and situation evaluation processes. Based on updated system data, the multi-layered digital twin architecture and system operation are re-optimized upon identification of new problems, ensuring sustained satisfaction of the operational objectives in the HetNets. This approach leverages the disclosed method to effectively manage and optimize the complex HetNets, ensuring high performance, balanced load distribution, and improved QoS for all UEs.

In this specific example, the multi-layered digital twin structure considers two layers: Layer-I as a higher layer for system digital twins and Layer-II as the lowest layer for element digital twins. As there is only one unaccomplished objective in this example, one system digital twin in Layer-I will be required. The system digital twin is designed to quickly identify the problematic areas with unsatisfied service provisioning within the complex HetNets. Two system digital twins with lower resolution are established, including the capacity model to explore the ability of service provisioning from the involved BSs to the demand model representing the service requirements from the distributed UEs. The capacity model can be straightforwardly established according to the transmission power and coverage range of the BS, while the demand model will need to understand the traffic required by each UE. The demand model posed to the BS j from all involved UEs i can be formed by

$${D}_{j} = {\sum }_{i} {x}_{i , j} {\hat{δ}}_{i}^{T} / {c}_{j} \qquad ( Eq . 1 )$$

where x_{i,j} is a binary indicator to be 1 only if UE i is associated with BS j, which has a coverage of

$${c}_{j} = π {r}_{j}^{2}$$

and radius of r^{j}. The data traffic

$${\hat{δ}}_{i}^{T}$$

can be estimated by any time-series forecasting technique, for example, the auto-regressive model, given by

$${\hat{δ}}_{i}^{T} ( τ ) = {\sum }_{l = 1}^{p} {ϕ}_{l} {δ}_{i}^{T} ( τ - l ) \qquad ( Eq . 2 )$$

with φₗ as the auto-regressive parameters.

Theoretically, data traffic δᵢ at UE i can be estimated by accumulating the data rate over a given period, while the data rate can be further calculated based on the instantaneous SINR from the corresponding BS. In practical network operation, the network traffic can also be measured by different network telemetry protocols, without hinging on the SINR for each UE.

UEs with higher data traffic will be more likely to associate with data-hungry applications and need extra attention for service provisioning. Moreover, the density of UEs within the coverage of the BS can also influence the activity of the specific area. Based on the physical location collected from each UE, the demand digital twin of the BS can be established as its accumulated demand from the associated UEs per unit area.

Finally, network hotspot is defined as the problematic areas within which the communication capacity of the BSs reaches the limitation of the demand they received. In such hotspots, the traffic should be carefully designed for the BSs and involved UEs to achieve desired network performance. By contrast, for BSs with significantly demand-supply gaps, the optimization will be less effective due to the insufficient benefit anticipated compared to the significant resource consumption. As a result, the overall user association problem within the complex HetNets can be decomposed into a series of sub-systems with potential problematic BSs and UEs to be carefully managed. For each identified problematic area, an element digital twin will be constructed.

The purpose of element digital twins in Layer-II is to dynamically achieve more fine-grained modeling of the necessary UEs in the identified hotspots to intelligently support network performance optimization and service provisioning. With the guidance of the time-varying system digital twin, the element digital twin is constructed with three subsequential steps relating to priority assignment, data processing, and digital twin modeling.

Different from the system digital twin that is established based on system-level data that are more relevant to KPIs, element digital twins will hinge on other system data, i.e., more detailed service-related network attributes, to accurately model UEs. Given the massive data generation and disordered transmission, it is necessary to assign priority to the UEs and attributes during digital twin construction. In this example, the element digital twins to be accurately modeled will be dynamically selected according to the identified hotspots in adapting to the real network demands.

Meanwhile, to ensure the timely processing of the massive data, not all UEs within are permitted to upload system data to the processing center. The UE selection preference is determined based on its traffic and location stability. The latter one is implied by the historical locations of each UE as an inversely proportional function to the changing frequency of its location. According to the data traffic and location stability, UEs are classified into two groups, namely, high-prioritized UEs with more value and low-prioritized UEs with less value. Only high-reward UEs will be permitted to upload their local sampling data to ensure sufficient communication resources are consumed with higher rewards and avoid extreme complexity during data collection.

Moreover, not all system data of high-reward UEs will be permitted to continuously upload to the processing center. By analyzing the data pattern of each attribute, only attributes with high variations will be required to be uploaded with higher frequency, which can further limit the resource used for element digital twin modeling. After gathering all attributes required for element digital twin modeling, proper data processing techniques will be conducted to improve data quality.

An element digital twin for the clock can be established for each service-related attribute to predict the local clock error compared to the time reference. Ideally, by compensating for the clock error in each data sample for all UEs, the data inaccuracy induced by local clock errors can be eliminated. Furthermore, different sampling capabilities and assigned transmission slots of UEs will lead to sampling misalignment among the multi-attribute data. To tackle this issue, local data samples can be processed into a series of resampled data by adopting proper interpolation techniques to enhance analysis accuracy.

Resampled data can be leveraged to establish the element digital twins with substantially enhanced accuracy. Due to the increased modeling requirement, forecasting methods with higher accuracy will be preferred to establish more fine-grained digital twins. The constructed element digital twins can be utilized to predict the behavior of the identified problematic area with enhanced accuracy for each relevant attribute. The parameters of these element digital twins can be integrated to update the system digital twin regarding the problematic subsystem to support efficient network management.

According to the predicted data for all relevant attributes within each identified problematic subsystem, the corresponding decomposed sub-problem can be straightforwardly solved by adopting any suitable mathematical technique like optimization and graph theory. Due to the reduced number of UEs and attributes, the complexity of problem-solving can be significantly reduced. By concurrently conducting the local optimization for all identified areas, the global optimal user association can be achieved with maximized service provisioning for the entire complex HetNets.

A comparison of the Layer-I and the Layer-II in the embodied example is summarized in TABLE 1. Layer-I is a higher layer in the multi-layered architecture, while Layer-II is the lowest layer. Their difference is reflected in a plurality of aspects, including scale, inputs, functions, outputs, and interactions. The differences of the layers are generated from different functions in each layer. To achieve system diagnostics, problem identification, and decision-making in Layer-I, a system-wide modeling is preferred, where the system KPI data, model parameters of element digital twins established in Layer-II, and external relevant data relevant to the network will be used to generate KPI predictions, guidance for subsequent modeling in Layer-II, and network operation decisions. In contrast, Layer-II aims to build detailed and accurate models for the specific elements to integrate system digital twins in Layer-I, where the guidance from Layer-I about the modeling target and the real-time and/or historical system data from the wireless devices in the telecommunication systems will be leveraged to generate detailed element digital twins that representing the behavior of the specific wireless device guided by the Layer-I.

TABLE 1
Comparison between the Layer-I and Layer-II in the dual-layered
digital twin architecture for Experimental Example 1.

| | Layer-I | Layer-II |
|---|---|---|
| Scale | Adaptive system-wide modeling | Individual modeling of each wireless |
| | | device |
| Inputs | System KPI data | Guidance from Layer-I about modeling |
| | Model parameters of the | targets |
| | element digital twin | Real-time and historical system data |
| | External relevant data | from the wireless devices and their |
| | | operation environment |
| Functionalities | System diagnostics | Modeling of each individual wireless |
| | Problem identification | device |
| | Decision-making | Pre-model data processing |
| Outputs | System digital twins | Element digital twins representing the |
| | Guidance for Layer-II | behavior of one attribute of one wireless |
| | Network operation decisions | device |
| Interactions | Layer-I guide the detailed | Parameters of Layer-II digital twins are |
| between layers | modeling of Layer-II | integrated into Layer-I digital twins |
| Data | Not needed for integrating | Yes, to improve modeling accuracy of |
| resampling | parameters from Layer-II | the wireless devices |
| Synchronization | Lower, in millisecond-level | Higher, in microsecond-level |
| accuracy | | |
| Computational | Lower | 50%-100% higher for detailed modeling |
| resource needed | | compared to Layer-I |
| Storage | Lower | 5-10 times of Layer-I to handle more |
| requirements | | system data from the wireless devices |
| Memory | Lower | 2-3 times of Layer-I for data processing |
| requirements | | and modeling |

In this specific case, other differences between Layer-I and Layer-II can be observed from the digital twin specifications. Layer-II prefer advanced data processing and modeling techniques, leading to higher hardware requirements in terms of computing power, storage, and memory. In contrast, digital twins in Layer-I are formed by combining existing model parameters, e.g., UE traffic demands and BS capacity, from element digital twins, thus significantly reducing hardware requirements. The resolution of digital twins in Layer-II could also be higher than the system digital twins in Layer-I for detailed representation.

### EXPERIMENTAL EXEMPLIFICATION: EXPERIMENTAL EXAMPLE 1 (PERFORMANCE EVALUATION)

Simulations are conducted to evaluate the performance of the dual-layered digital twin paradigm and its effectiveness in enhancing traffic engineering.

### A. Simulation Settings

In the simulations, we consider the heterogeneous networks with 50-150 UEs supported by 1 macro cell base station (BS) and 29 randomly deployed small cell BSs with transmission powers of 40 dBm and 17 dBm, respectively. Proper distances are maintained among different types of BSs. Different types of UEs are considered, including smartphones, laptops, and VR headsets. The operational objective in this simulation is to improve the satisfaction level of UEs by optimizing the user association, while relevant KPIs include network throughput, latency, and packet loss rate. As a result, system data regarding the KPIs of the HetNets, including user traffic load, QoS requirements, and link quality, will be reported by the built-in capabilities in each UE to the BSs. Moreover, the communication channels are designed based on [12], with log-normal shadowing fading and small-scale fading. The power of background AWGN noise is-104 dBm, while we considered two path loss models for macro cells and small cells, given by 15.3+37.6 log₁₀(d) and 8.46+20 log₁₀(d)+0.7d, where d is the distance from UE to the corresponding BS. Penalties will be applied for inter-cell communications and larger-scale networks can be considered by deploying more BSs.

### B. Performance Analysis

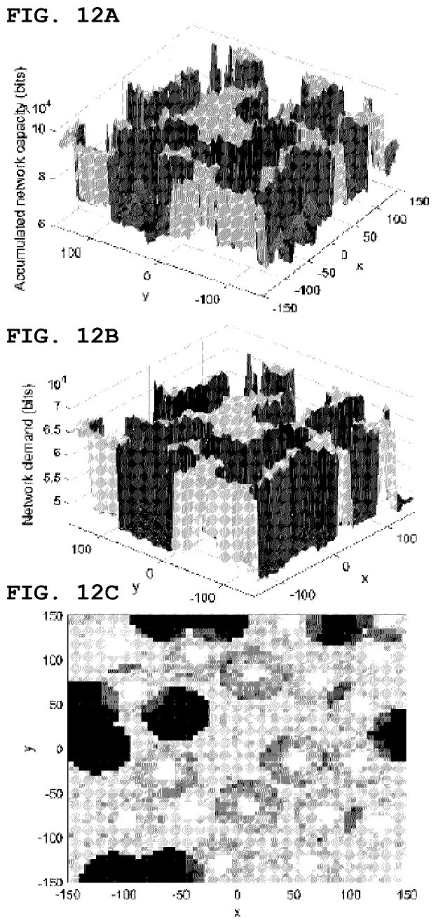

The modeling of the entire 6G HetNets is achieved by two successive steps in the proposed dual-layered paradigm. Specifically, the performance of the system digital twin in Layer-I, as shown in FIG. 12, is composed of three components. To rapidly identify the target areas to be focused on during network optimization, the communication capacity of the network and the demand from the correspondingly involved UEs are separately modeled. As shown in FIG. 12a, the capacity is modeled by allocating a UE throughout the network with a predefined period for each area. By contrast, the demand map is obtained according to the distribution of the UEs, while nearby UEs will jointly contribute to the network demand for a given BS. Therefore, by comparing the capacity and demand maps for each area, the network hotspots are dynamically determined in FIG. 12c highlighted as dark areas, which can support the succeeding network optimization.

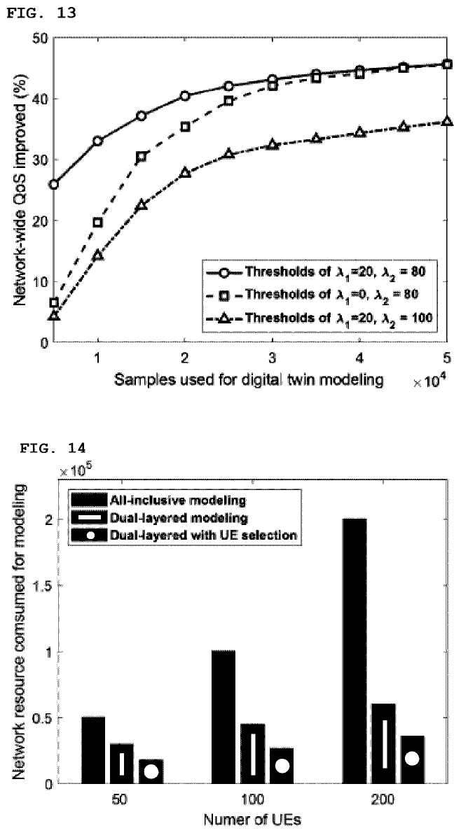

Based on the hotspots identified, problematic areas of the network that require particular management can be intelligently selected for refined element digital twins in Layer-II. The parameters from these element digital twins will be further integrated and updated into a new system digital twin to operate the HetNets. Proper traffic engineering will then be concurrently conducted for each identified area based on the updated system digital twins to efficiently achieve network congestion control and QoS satisfaction. Moreover, threshold-based K-means clustering is used to intelligently select UEs for data upload. As shown in FIG. 13, the network-wide QoS satisfaction is improved by more than 50% after adopting the dual-layered digital twin paradigm. Additionally, by tuning the thresholds during UE selection, non-ideal UEs are intelligently filtered. It can be observed that 11 can help enhance the efficiency by recognizing UEs that do not need extra resources, while 22 can prevent wasting extra resources on UEs with overwhelming demands. Therefore, the dual-layered method with UE selection can enhance the efficiency and network performance simultaneously.

Furthermore, the overall resource consumption for network optimization is compared among three different digital twin modeling scenarios, namely, all-inclusive, dual-layered, and dual-layered with UE selection, as demonstrated in FIG. 14, where the same QoS demands are applied for all schemes. Meanwhile, three network scales are separately considered. It can be observed that the dual-layered digital twin paradigm can satisfy the QoS demand with significantly reduced network overhead (more than 50% considering resources used in both Layer-I and Layer-II digital twins) by intelligently and dynamically identifying the hotspots.

Additionally, the UE-selection mechanism can further reduce resource consumption by filtering devices with insufficient values or overly stringent demands that cannot be achieved during network optimization.

For illustrative purposes, the following example can be helpful in understanding association of KPI, measured data, objects and model parameters in a telecommunication network implementation of a multi-layered digital twin approach:

### Operational Objective: Enhance Network Capacity and User Experience.

### KPIs

Network Capacity (data throughput)
Coverage Area (signal strength and quality)
User Experience (Quality of Service-QoS)

### System Data to Measure

Traffic load data
Signal strength (RSSI) and signal quality (SINR)
User mobility patterns

### Sensing Component

Base station sensors
RF module in user devices
GPS sensor

### Model Parameters of Element Digital Twins

Transmission Power, Path Loss Coefficient, and/or Machine learning model coefficients

### Connected Objects to be Controlled

User devices
Interference mitigation devices (for example, filter or smart antenna components embedded in a base station or user device)

### Actions to be Done to Improve the System Performance

Dynamic resource allocation on BSs
Redistributing traffic loads across cells to avoid congestion
Implement interference cancellation techniques

### EXPERIMENTAL EXEMPLIFICATION: EXPERIMENTAL EXAMPLE 1 (REFERENCE LIST)

[1]. X. Wang, J. Mei, S. Cui, C. Wang, and X. Shen, “Realizing 6G: The operational goals, enabling technologies of future networks and value-oriented intelligent multi-dimensional multiple access,” IEEE Netw., vol. 37, no. 1, pp. 10-17, 2023.
[2]. H. X. Nguyen, R. Trestian, D. To, and M. Tatipamula, “Digital twin for 5G and beyond,” IEEE Commun. Mag., vol. 59, no. 2, pp. 10-15, 2021.
[3]. N. P. Kuruvatti, M. A. Habibi, S. Partani, B. Han, A. Fellan, and H. D. Schotten, “Empowering 6G communication systems with digital twin technology: A comprehensive survey,” IEEE Access, vol. 10, pp. 112 158-112 186, 2022.
[4]. Y. Xiao, J. Liu, J. Wu, and N. Ansari, “Leveraging deep reinforcement learning for traffic engineering: A survey,” IEEE Commun. Surv. Tutor., vol. 23, no. 4, pp. 2064-2097, 2021.
[5]. W. Li, F. Zhou, K. R. Chowdhury, and W. Meleis, “QTCP: Adaptive congestion control with reinforcement learning,” IEEE Trans. Netw. Sci. Eng., vol. 6, no. 3, pp. 445-458, 2019.
[6]. O. Ahmed, F. Ren, A. Hawbani, and Y. Al-Sharabi, “Energy optimized congestion control-based temperature aware routing algorithm for software defined wireless body area networks,” IEEE Access, vol. 8, pp. 41 085-41 099, 2020.
[7]. S. Mihai, M. Yaqoob, D. V. Hung, W. Davis, P. Towakel, M. Raza, M. Karamanoglu, B. Barn, D. Shetve, R. V. Prasad, H. Venkataraman, R. Trestian, and H. X. Nguyen, “Digital twins: A survey on enabling technologies, challenges, trends and future prospects,” IEEE Commun. Surv. Tutor., vol. 24, no. 4, pp. 2255-2291, 2022.
[8]. P. Jia and X. Wang, “A new virtual network topology based digital twin for spatial-temporal load-balanced user association in 6G HetNets,” IEEE J. Sel. Areas Commun., vol. 41, no. 10, pp. 3080-3094, 2023.
[9]. X. Shen, J. Gao, W. Wu, M. Li, C. Zhou, and W. Zhuang, “Holistic network virtualization and pervasive network intelligence for 6G,” IEEE Commun. Surv. Tutor., vol. 24, no. 1, pp. 1-30, 2022.
[10]. S. K. Bhatia et al., “Adaptive K-means clustering.” in FLAIRS conference, 2004, pp. 695-699.
[11]. P. Jia, X. Wang, and X. Shen, “Accurate and efficient digital twin construction using concurrent end-to-end synchronization and multi-attribute data resampling,” IEEE Internet Things J., vol. 10, no. 6, pp. 4857-4870, 2023.
[12]. F. Fang, G. Ye, H. Zhang, J. Cheng, and V. C. M. Leung, “Energy-efficient joint user association and power allocation in a heterogeneous network,” IEEE Trans. Wirel. Commun., vol. 19, no. 11, pp. 7008-7020, 2020.

### EXPERIMENTAL EXEMPLIFICATION: EXPERIMENTAL EXAMPLE 2 (DATA SYNCHRONIZATION AND RESAMPLING FOR MULTI-ATTRIBUTE DATA)

Digital twin modeling can rely on cohesive processing of multiple sensing attributes, for example multiple sensing attributes of a single connected object. The misalignment of the time information associated with different attributes will cause a significant negative impact on the modeling accuracy. A two-step attribute alignment scheme is designed for pre-modeling data processing, including clock offset compensation and multi-attribute data resampling.

For electrical devices, an oscillator-driven clock is typically embedded to provide local time information continuously. Simply packaged crystal oscillators (SPXO), widely utilized in large-scale systems to reduce implementation costs, cannot generate stable timestamps due to defective manufacturing and lack of temperature compensation techniques. The time inaccuracy of the sensing attribute i is mainly dominated by the local clock of its connected object, which is associated with the initial clock skew αᵢ and clock offset βᵢ, while an unacceptable clock error will occur without proper time synchronization methods. Compared to the time reference t, a time-varying clock error ϵᵢ will occur, written as

ϵᵢ(t)=αᵢ(t)t+βᵢ−t=(αᵢ(t)−1)t+βᵢ (Eq. 3)

In long-term operations, clock skew αᵢ of inexpensive connected objects will be inconsistent with the variation of external operating conditions, e.g., ambient temperature, resulting in even more unpredictable clock inaccuracy. Lack of temporal consistency among multiple sensing attributes caused by this clock error can severely affect the modeling accuracy of digital twins, while the traditional packet-switching-based time synchronization methods will inevitably lead to high communication overhead. Based on this observation, a model-based offset estimation scheme is designed in this section to support the digital twin construction by properly analyzing the sequential timestamps of each attribute.

Timestamps of each local connected object are periodically uploaded to the server for virtual clock modeling. The main challenge of clock modeling is to accurately estimate the clock skew and offset based on the timestamps. Similar to Precision Time Protocol (PTP), the estimation of the initial clock offset βᵢ of each clock is obtained by analyzing the first two pairs of timestamps, given by

$${\hat{β}}_{i} = \frac{{t}_{0}^{2} - {t}_{0}^{1} + {t}_{0}^{3} - {t}_{0}^{4}}{2} + \frac{{d}_{2} - {d}_{1}}{2} \qquad ( Eq . 4 )$$

where d₁ and d₂ are the propagation delay between the two nodes in the two successive links. By assuming the delay is symmetric, the estimated offset can be further simplified into

$${\hat{β}}_{i} = \frac{{t}_{0}^{2} - {t}_{0}^{1} + {t}_{0}^{3} - {t}_{0}^{4}}{2} \qquad ( Eq . 5 )$$

Different from clock offset estimation, timestamps from the local connected objects are not required during the clock skew estimation, which can reduce the network overhead of clock modeling by half. A series of samples for attribute i will be uploaded to the server for digital twin construction with a predefined interval τᵢ. After obtaining each attribute sample, the server will record the receiving time, while ideally, the intervening period between two successive receiving instants should be identical to the predefined interval, i.e., t₂−t₁=τᵢ. However, there will be a difference between the two intervals due to the existence of the clock skew, which can be thereby estimated by

$${\hat{α}}_{ei}^{1} = \frac{{t}_{2} - {t}_{1}}{τ} \qquad ( Eq . 6 )$$

where

$${\hat{α}}_{ei}^{1}$$

denotes the first estimation of the relative skew between the server and the sensing attribute i. After receiving a series of samples, the estimation of the clock skew can be improved by taking the average of the historical values, given by

$${\hat{α}}_{ei} = \overline{{\sum }_{s = 2}^{{S}_{l}} \frac{{t}_{s} - {t}_{s - 1}}{{τ}_{l}}} = \frac{{t}_{{S}_{i}} - {t}_{1}}{{τ}_{i} ( {S}_{i} - 1 )} \qquad ( Eq . 7 )$$

where Sᵢ is the overall samples collected for attribute i.

Therefore, the relative clock model of the attribute i can be written as

$${\hat{C}}_{i} ( t ) = {\hat{α}}_{ei} t + {\hat{β}}_{i} = \frac{{t}_{{S}_{i}} - {t}_{1}}{{τ}_{i} ( {S}_{i} - 1 )} t + \frac{{t}_{0}^{2} - {t}_{0}^{1} + {t}_{0}^{3} - {t}_{0}^{4}}{2} \qquad ( Eq . 8 )$$

which can be straightforwardly used to predict the relative clock offset of the attribute i compared to its server. Another two pairs of timestamps will be exchanged between the local sensor and the server for validation.

After establishing the virtual clock model for each sensing attribute, the series of samples collected from each connected object can be compensated for according to the real-time clock errors obtained from the estimated clock parameters, given by

\hat{ϵ}ᵢ(t)=(\hat{α}ₑᵢ−1)t+\hat{β}ᵢ (Eq. 9)

The sample of attribute i at a given instant t, i.e., sᵢ(t), can be thereby corrected as

Ŝᵢ(t)=Sᵢ(t−\hat{ϵ}ᵢ(t)) (Eq. 10)

where the temporal misalignment caused by clock errors can be eliminated if accurate clock modeling is achieved.

However, due to the limitation of different connected objects in terms of their heterogeneous sampling rates and dynamic task schedules, the sampling instants for each attribute about the same connected object will be non-simultaneously, which can lead to temporal misalignment among the multi-attribute samples. This incoherence will inevitably cause modeling errors if the raw system data are used for digital twin training without proper processing. To address this issue, an adaptive distance-weighted K-nearest neighbors (ADWKNN) algorithm is proposed for multi-attribute data resampling, as illustrated in Algorithm 1.

The main difference between the ADWKNN algorithm and the traditional distance-weighted K-nearest neighbors (DWKNNs) lies in the adaptive selection of the K nearest neighbors according to the multi-attribute samples. More specifically, ADWKNN comprises two main steps, namely, optimal nearest neighbors selection and adaptive distance-weighted resampling calculation. Aiming to select the optimal nearest neighbors of the attribute i, a series of original data samples with the corresponding sampling instants should be recorded at the server. The desired resampling instants will be selected as the reference so that the samples of multiple attributes can be fully aligned with each other in the time domain. To select the optimal K_{i,j} at the j-th resampling instant of the attribute i, denoted as t_{i,j}^{r}, its time difference

$${δ}_{i , j}^{rs}$$

and Euclidean distance

$${𝒟}_{i , j}^{rs}$$

compared to the original recorded data samples are calculated respectively, given by

$${δ}_{i , j}^{rs} = {t}_{i , j}^{r} - {t}_{i}^{s} and \qquad ( Eq . 11 )$$

$${𝒟}_{i , j}^{rs} = \sqrt{{( {t}_{i , j}^{r} - {t}_{i}^{s} )}^{2}} \qquad ( Eq . 12 )$$

where

$${t}_{i}^{s}$$

is a vector containing the original data sampling instants about the same attribute i.

Due to the randomness of local samples, some of the original samples would be excessively distant from the desired resampling instant, which can lead to inaccurate resampling results. To filter uncorrelated faraway data samples, the median of the distance vector

$${𝒟}_{j}^{rs}$$

is calculated as a threshold, which can help to discover excessive elements. Any original data samples with a distance greater than the median will be removed from the candidate neighbor set, while the

Algorithm 1: Find Optimal K Using Adaptive Distance-
Weighted KNN Data Resampling for Each Resample

| | |
|---|---|
| Input: | Synchronized samples ŝᵢⱼ, sampling instants tₛ, |
| | resampling instants tᵣ |

$Output : Resampled data {\check{s}}_{i}^{j}$

| 1 | for j = 1 : [symbol] do | | | |
|---|---|---|---|---|
| 2 | \| | for s = 1 : [symbol] do | | |
| 3 | \| | \| | $Calculate time difference {δ}_{m}^{r s} based on Eq . 11$ | |
| 4 | \| | \| | $Obtain Euclidean distance {𝒟}_{m}^{rs} according to$ | |
| | \| | \| | Eq. 12 | |
| 5 | \| | Obtain median of Euclidean distance [symbol] ^{rs} | | |
| 6 | \| | for s = 1 : [symbol] do | | |
| 7 | \| | \| | $if {𝒟}_{m}^{r s} \geq {\tilde{D}}^{rs} then$ | |
| 8 | \| | \| | \| | $Remove {𝒟}_{m}^{rs} from {𝒟}^{rs}$ |

| 9 | \| | Sort [symbol] ^{rs} in an ascending order | | |
|---|---|---|---|---|
| 10 | \| | List δ^{rs} by following the order of [symbol] ^{rs} | | |
| 11 | \| | Set initial number of neighbors K_{i,j} = 2 | | |
| 12 | \| | $Sum the nearest two instants {\hat{δ}}^{min} = \vert {δ}_{1}^{rs} + {δ}_{2}^{r s} \vert$ | | |
| 13 | \| | for s = 2 : # [symbol] ^{rs} do | | |
| 14 | \| | \| | Accumulate differences \hat{δ}(s) based on Eq. 13 | |
| 15 | \| | \| | if \hat{δ}(s) ≤ \hat{δ}^{min} then | |
| 16 | \| | \| | \| | Replace minimal value \hat{δ}^{min} = \hat{δ}(s) |
| 17 | \| | \| | \| | Update proper neighbors K_{i,j} = s |

| 18 | \| | Sort the K_{i,j} samples in an ascending order | |
|---|---|---|---|
| 19 | \| | for k = 1 : K_{i,j} do | |
| 20 | \| | \| | Calculate the k^{th} weight according to Eq. 15 |

| | | |
|---|---|---|
| 21 | \| | Obtain weighted resampling š_{i,j} based on Eq. 16 |

distance of the remaining samples

$${𝒟}_{j}^{rs}$$

will be sorted in ascending order so that the sample with the strongest correlation will be listed as the first element.

The selection of K_{i,j} aims at minimizing the imbalance of the impact from original data samples during data interpolation. In other words, simply considering more unidirectional neighbors (i.e., only before or after) will not be beneficial to the final resampling accuracy. Motivated by this observation, the accumulated difference \hat{δ}(s) of each original sample s is calculated, given by

$$\hat{δ} ( s ) = {\sum }_{l = 1}^{s} \vert {δ}_{j}^{r s} ( l ) \vert , ∀ s = \{ 2 , 3 , … , S \} \qquad ( Eq . 13 )$$

where S is the number of samples after initial filtering, while at least two of the samples should be selected to meet the basic requirement, i.e., S≥2. By observing the number of samples leading to the minimized accumulated difference \hat{δ}^{min}, the optimal K_{i,j} can be obtained as

K_{i,j}={s|\hat{δ}(s)=\hat{δ}ₘᵢₙ,2≤s≤S} (Eq. 14)

After obtaining the optimal K_{i,j} for each desired resampling instant

$${t}_{j}^{r} ,$$

a distance-weighting factor for each original system data can be thereby calculated. The weight ω_{ρ} associated with the ρ-th closest neighbor is defined as

$${ω}_{ρ} = \{ \begin{matrix}1 , & if {𝒟}_{{K}_{i , j}}^{rs} = {𝒟}_{1}^{rs} \\ \frac{{𝒟}_{{K}_{i , j}}^{rs} - {𝒟}_{ρ}^{rs}}{{𝒟}_{{K}_{i , j}}^{rs} - {𝒟}_{1}^{rs}} & otherwise .\end{matrix} \qquad ( Eq . 15 )$$

Based on the obtained weighting factors, the final resampling result of the j-th resampling instant for attribute i can be calculated by taking the weighted average of the K_{i,j} neighboring samples, given by

$${s}_{i , j}^{r} = \frac{{\sum }_{k = 1}^{{K}_{i , j}} {ω}_{k} {\hat{s}}_{i , j}^{k}}{{\sum }_{k = 1}^{{K}_{i , j}} {ω}_{k}} \qquad ( Eq . 16 )$$

where

$${\hat{s}}_{i , j}^{k}$$

is the data sample belongs to the k-th nearest neighbor of the resampling instant

$${t}_{i , j}^{r}$$

clock compensation.

Data resampling provides an opportunity for heterogeneous sensors to adjust their sampling rate according to the resampling performance. In this subsection, a feedback-based sampling rate adjustment mechanism is designed at the server, aiming at maintaining the application-specific processing accuracy while minimizing the network overhead during data uploading.

The main purpose of sampling adjustment is to maximize the data efficiency for resampling. Typically, the initial resampling accuracy will be excessive or insufficient compared to the application-specific requirement due to data redundancy or low data rate, respectively. As a direct result, either unnecessary resource wasting or non-ideal data modeling accuracy will be expected during digital twin construction. To address these issues, the server will be responsible for estimating the initial data resampling accuracy by conducting cross-validation based on the attribute samples collected. Attribute with an exceeding or insufficient data resampling accuracy compared to the predefined requirement will be asked to adjust its local sensing rate accordingly. Furthermore, different optimization techniques, like golden-section search and Ternary search, can be utilized to determine the optimal local sampling rate \hat{f} of each attribute efficiently in meeting the resampling accuracy Qᵢ, which can be generalized as

\hat{f}ᵢ=arg min_{f}_{ᵢ}Ψ(fᵢ)−Qᵢ (Eq. 17)

where fᵢ is the local sampling rate for attribute i, while Ψ(fᵢ) is the data resampling accuracy obtained based on the cross-validation.

In addition, the attribute selection for digital twin modeling should also be application-driven since not all attributes collected from the local connected object will be useful. Therefore, it is necessary to only upload correlated information for data resampling and digital twin creation. A penalized-regression-enabled digital twin creation method is introduced in the next section to filter the unnecessary attributes during digital twin modeling. By recording the filtered information at the server, local connected object can further adjust the information to be uploaded, which can significantly help to reduce the network resource consumption and successive digital twin modeling complexity.

Based on the resampled data, digital twins can be established at the server by investigating the temporal relationships among the multiple sensing attributes. The digital twins can be identified and modeled by a series of statistical tools, including Tikhonov regularization, least absolute shrinkage and selection operator (Lasso), and sparse identification of nonlinear dynamics (SINDy), based on the nature of the connected objects to be modeled and the type of data samples. Some selection criteria include the sparsity of the system data, the number of attributes, and the linearity of the relations.

To give some general ideas for digital twin creation, Lasso is selected in this section as an example after careful data processing. As a mature system identification approach, Lasso can achieve good performance for sparse data with multicollinearity. Moreover, Lasso can help to filter uncorrelated information from a large number of attributes to reduce the model complexity for comprehensive digital twin modeling. More specifically, the goal of Lasso in the proposed scheme is to solve the optimization problem defined as

\hat{η}=argmin_{η}L(š) (Eq. 18)

L (š) is the loss function to be minimized, given by

$$L ( {s}^{⌣} ) = {\sum }_{r = 1}^{ℛ} {‖ {{s}^{⌣}}_{r}^{out} - {\sum }_{i}^{𝒥} {{s}^{⌣}}_{r}^{in} {η}_{i} ‖}^{2} + λ {\sum }_{i}^{𝒥} \vert {η}_{i} \vert \qquad ( Eq . 19 )$$

where [symbol] is the total number of recorded attributes to be modeled and R is the total number of resampled data for each attribute, respectively. In the loss function

$${{s}^{⌣}}_{j}^{in} and {{s}^{⌣}}_{j}^{out}$$

are the input attribute and output attribute obtained after data resampling. ηᵢ is the digital twin parameter for each attribute to be solved, while a penalized term defined by a nonnegative regularization parameter λ is added at the end to avoid over-fitting issues during optimization. Therefore, by properly conducting the pre-modeling data resampling for each involved connected objects and minimizing the loss function, the parameters of the digital twin can be identified, and replication of the model can be established accordingly in the digital domain.

### EXPERIMENTAL EXEMPLIFICATION: EXPERIMENTAL EXAMPLE 2 (PERFORMANCE EVALUATION)

Experiments are conducted to evaluate the performance of the data processing techniques including synchronization and resampling to support multi-layered digital twin.

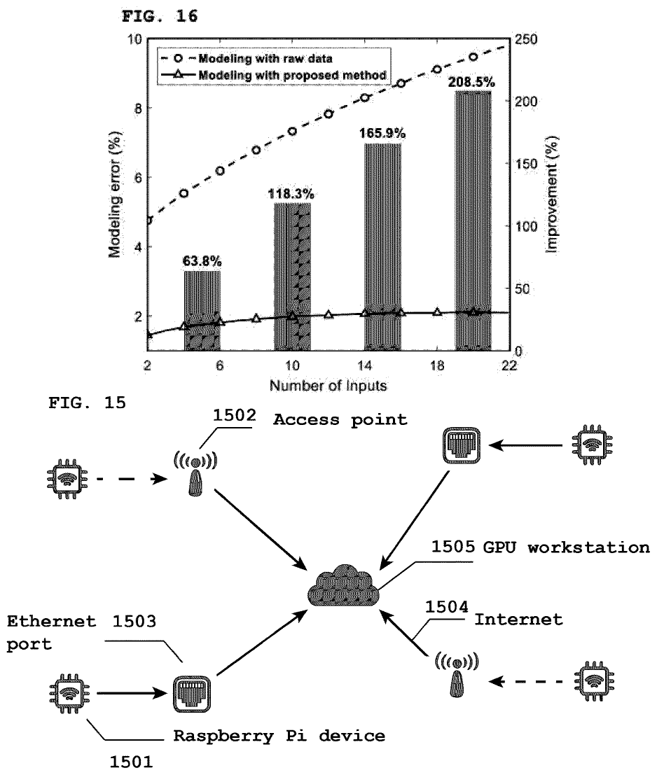

In the experiment, we consider a distributed system with a plurality of devices to establish a system digital twin by integrating the distributed inputs. Referring to FIG. 15, different amount of Raspberry Pi devices 1501, ranging from 2 to 22, are placed in remote areas as the connected objects for local environment data collection by leveraging the sensors installed, including thermistors and humidity sensors. These devices 1501 are connected to the Internet 1504 via different network access methods, for example, Wi-Fi access point 1502 or Ethernet port 1503, to send the local sensed data and local timestamps to the centralized GPU workstation 1505 for centralized digital twin formation. The local sensed data including local temperature and humidity level, while the local timestamps are transmitted in ISO 8601 format to record the data sampling instants. After collecting the distributed system data, the center GPU workstation 1505 will conduct data processing, including unifying the timestamps into the same format, synchronizing data to address the clock offset, unifying all data samples according to the same format, and resampling all system data into the same sampling frequency. After fully unifying the distributed system data, accurate digital twin can be established regarding the environmental profile of the system in terms of the temperature gradients, humidity level, and air quality, with significantly enhanced accuracy due to improved temporal correlation. To build digital twins, an AI technique, nonlinear autoregressive neural network with external input, is adopted to analyze the temporal correlations of the distributed system data to enhance the modeling accuracy.

Referring to FIG. 16, the modeling error of the entire system digital twin will increase with more inputs involved. By adopting the pre-model data processing, the modeling error can be significantly reduced. For a complex system of 20 inputs, the modeling error of the proposed method can be as low as 2%, which is improved 208.5% compared to the case of modeling the raw system data from distributed Raspberry Pi devices. The data uncertainties caused by local clock offset, data sampling inconsistency, non-deterministic network condition, and heterogeneous data formats are mitigated.

### EXPERIMENTAL EXEMPLIFICATION: EXPERIMENTAL EXAMPLE 3 (OPERATING A COMPLEX SUPPLY CHAIN SYSTEM USING MULTI-LAYERED DIGITAL TWINS)

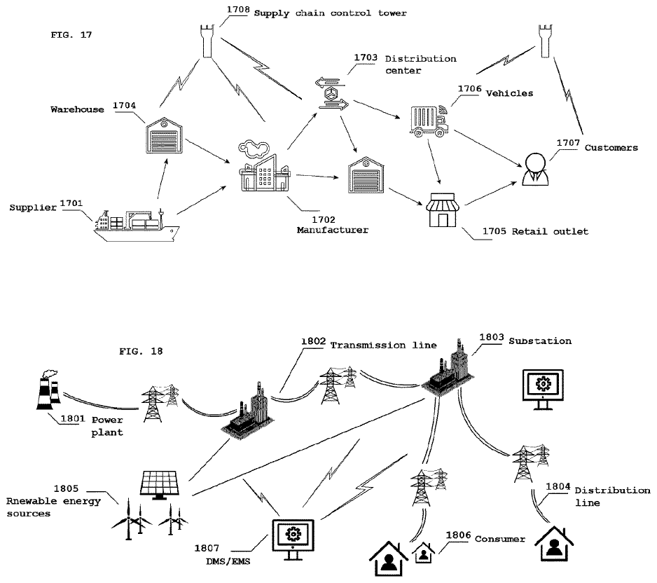

Referring to FIG. 17, a complex supply chain system is considered a complex system, typically consisting of a plurality of connected objects including suppliers 1701 providing raw materials, manufacturers 1702 transforming these materials into finished products, distribution centers 1703 distributing products to various locations, regional warehouses 1704 storing products before distribution, retail outlets 1705 as platforms for customer purchasing, transportation vehicles 1706 moving products between different locations, and customers 1707 who purchase and use the products. These connected objects are associated with one or more sensor modules 301 or 405 that might include production output trackers, machine utilization monitors, inventory level sensors, thermistors, humidity sensors, shelf stock sensors, GPS trackers, purchase history trackers, and RFID tags, to generate system data with different attributes about the supply chain system, each reflecting a certain aspect of the system. The system data from the supply chain system might include historical sales data, inventory levels, supplier lead times, transportation data, demand forecasts, and environmental conditions. The supply chain control towers 1708, serving as servers 103 in the disclosed invention, are the central processing hubs providing the processing capabilities necessary to manage the system data from the supply chain system and establish digital twins for different connected objects. Such a supply chain system is typically highly dynamic due to fluctuating customer demands, transportation delays, and varying supplier reliability. Using digital twins to achieve optimal inventory distribution and supplier management is a feasible approach by predicting the dynamics within the complex supply chain system and forecasting situations of adopting different management strategies.

However, the use of digital twins for managing the complex supply chain system is complex from three aspects. First, the complex data collection process due to the routine, non-selective, and unprioritized data gathering from heterogeneous connected objects like retail outlets, transportation vehicles, and customers. Collecting all available system data from all connected objects could consume excessive resources. Meanwhile, the schedule of data upload from distributed connected objects will become overly complex, deteriorating the management efficiency of the supply chain system. Second, the complex data processing, as well as digital twin modeling and updating due to the centralized processing of massive, multi-attribute, multi-source, and temporally inconsistent system data from all connected objects, can make the digital twin establishment inefficient, inaccurate, and/or outdated. Third, the finally formed optimization problem, which consists of a large number of connected objects and their associated attributes, will become overly complex and difficult, if not impossible, to solve with traditional mathematical techniques.

The utilization of the presently disclosed system and method for the construction of multi-layered digital twins in a complex system can help achieve low-complexity management of the supply chain system. The management process begins by identifying the operational objectives of the supply chain system. The operational objectives in such a system include optimizing overall supply chain performance by enhancing inventory management, balancing supply and demand, and improving customer satisfaction. Then, a series of steps to evaluate the system situation is conducted by analyzing the collected system data from different parts of the supply chain system. Specific elements from the selected connected objects relevant to these operational objectives are prioritized for data collection, where an element is defined as one attribute of the corresponding connected object.

The servers continuously monitor the complex supply chain system by collecting system data from these prioritized elements. The system data could be reported through wireless networks or wired connections to the supply chain control tower. This collected system data is processed to obtain KPI data, which represent the operational situations of the overall complex system or its subsystems. Relevant KPIs for the operational objectives in such a system might include order fulfillment rate, inventory turnover, inventory level, transportation cost, lead time, and customer satisfaction level. The KPI data are dynamically obtained by methods such as analyzing system statistics, collecting reported KPI data, and model-based KPI prediction. By comparing the KPI data with the operational objectives, potential problematic subsystems are identified. For example, by comparing the current inventory level and the optimal inventory situation, a gap indicating potential areas of stockouts can be identified. Other gaps, including excess inventory, transportation delays, or low customer satisfaction, are all potential problems in the complex supply chain system needing efficient management strategies.

Upon identifying these problematic subsystems, the severity of unaccomplished or unsatisfied operational objectives is reported for further operation and optimization. Based on this evaluation, the multi-layered digital twin construction strategy is developed, prioritizing the creation of digital twins for problematic subsystems with severe problems. If the servers identify that all operational objectives have been accomplished, they continue to monitor the complex supply chain system by collecting system data from the connected objects. This continuous monitoring process ensures that the system can dynamically re-optimize the multi-layered digital twin architecture and operate the overall supply chain system upon identifying new problems, thereby sustaining the satisfaction of the operational objectives of the complex supply chain system.

With one or more unaccomplished operational objectives identified, the hierarchical multi-layered digital twin architecture is designed and adapted to be responsive to system situations and operational problems. The multi-layered digital twin architecture comprises one or more higher layers for system digital twins configured to model and manage one or more operational objectives of the system or subsystems, and one lowest layer constructing element digital twins or collecting system data from the connected objects based on guidance received from the higher layers, where each element digital twin represents the behavior of its respective connected object. Each digital twin layer is characterized by different scales, structures, functionalities, inputs, outputs, and modeling processes.

In the context of managing the supply chain system using multi-layered digital twins, the functionalities of the higher layers include continuously evaluating the system situation, identifying problems such as inventory imbalances or transportation inefficiencies, analyzing the root causes of these problems, and making decisions for the operation of the system or subsystems. The lowest layer processes system data and conducts specific modeling for each selected connected object, like a retail outlet or customer identified by the higher layers.

The interactions between the layers of the multi-layered digital twin architecture in the supply chain system are characterized by the lowest layer transmitting parameters of each element digital twin to the higher layers, such as inventory levels and demand forecasts. A higher layer transmits parameters of its subsystem digital twin, such as regional inventory distributions, to even higher layers. A higher layer with a system digital twin transmits modeling guidance and operation commands for one subsystem, such as a regional warehouse, to another higher layer with the subsystem. A higher layer with a subsystem digital twin transmits modeling guidance and operation commands for the connected objects to guide the lowest layer, ensuring optimized operations across the entire supply chain system.

The data gathering, data processing, and digital twin modeling processes are designed to be vertically integrated and dynamically adjusted based on system situations. System data from connected objects is processed at the supply chain control tower to establish element digital twins, which model the specific element such as the inventory levels and demand forecasts of individual outlets. These element digital twins feed into the higher layers of the system digital twin, which evaluates the overall performance of the supply chain system and identifies areas needing optimization.

The multi-layered digital twins are utilized to generate decisions and optimize system performance, thereby actively satisfying the operational objectives of the supply chain system. This includes dynamically adjusting inventory levels, supplier orders, and transportation schedules to enhance inventory management, balance supply and demand, and improve customer satisfaction. Additionally, a human-in-the-loop digital twin structure can be developed to flexibly integrate autonomous operations and inputs from human operators. This structure enables a range of operation modes, including fully autonomous operation, human-guided operation, and integrated hybrid operation.

The system conditions are continuously monitored by repeating the system data collection and situation evaluation processes. Based on updated system data, the multi-layered digital twin architecture and system operation are re-optimized upon identification of new problems, ensuring sustained satisfaction of the operational objectives in the supply chain system. This approach leverages the disclosed method to effectively manage and optimize the complex supply chain system, ensuring high performance, balanced supply and demand, and improved customer satisfaction.

For illustrative purposes, the following example can be helpful in understanding association of KPI, measured data, objects and model parameters in a supply chain implementation of a multi-layered digital twin approach:

Operational Objective: Enhance efficiency and reliability of operations.

### KPIs

Order fulfillment rate
Delivery lead time
Inventory accuracy

### System Data to Measure

Order status and fulfillment data
Transit times and shipping durations
Inventory levels and discrepancies

### Sensing Components

Order management systems (for order status and fulfillment)
GPS trackers (for transit times and shipping durations)
Inventory sensors (RFID tags, barcode scanners)

### Model Parameters of Element Digital Twins

Transportation efficiency coefficient and/or Machine learning model coefficients

### Connected Objects to be Controlled

Order processing systems (enterprise resource planning (ERP) systems)
Transportation vehicles (trucks, ships, planes)·
Warehouse storage systems (racking systems, automated storage and retrieval systems)

### Actions to Improve System Performance

Optimize order processing workflows by streamlining order entry, picking, and packing processes.
Enhance transportation planning by planning and adjusting transportation routes, schedules, and methods to minimize delays and reduce costs.
Improve inventory management practices by implementing automated inventory updates to enhance accuracy and reduce discrepancies.

### EXPERIMENTAL EXEMPLIFICATION: EXPERIMENTAL EXAMPLE 4 (OPERATING A COMPLEX SMART GRID SYSTEM USING MULTI-LAYERED DIGITAL TWINS)

Referring to FIG. 18, a smart grid system is considered a complex system, typically consisting of a plurality of connected objects, including power plants 1801 generating electricity, transmission lines 1802 transporting electricity over long distances, substations 1803 transforming voltage levels, distribution lines 1804 delivering electricity to end-users, renewable energy sources 1805 such as solar panels and wind turbines, and consumers 1806 who use the electricity. These connected objects are associated with one or more sensor modules 301 or 405, such as power output monitors, voltage sensors, current sensors, frequency meters, and smart meters, to generate system data with different attributes about the smart grid, each reflecting a certain aspect of the system. The system data from the smart grid might include power generation data, transmission and distribution losses, voltage and current levels, energy consumption data, and renewable energy output. The distribution management systems (DMS) or energy management systems (EMS) 1807, serving as servers 103 in the disclosed invention, provide the processing capabilities necessary to process the system data from the smart grid and establish digital twins for different connected objects. Such a smart grid is typically highly dynamic due to fluctuating energy demands, variable renewable energy generation, and grid stability requirements. Using digital twins to achieve optimal energy distribution, load balancing, and grid stability is a feasible approach by predicting the dynamics within the complex smart grid and forecasting situations of adopting different management strategies.

However, the use of digital twins for managing the complex smart grid is challenging due to three aspects. First, the complex data collection process due to the routine, non-selective, and unprioritized data gathering from heterogeneous connected objects like renewable energy sources, transmission lines, and consumers. Collecting all available system data from all connected objects could consume excessive resources. Meanwhile, the schedule of data upload from distributed connected objects will become overly complex, deteriorating the management efficiency of the smart grid. Second, the complex data processing, as well as digital twin modeling and updating due to the centralized processing of massive, multi-attribute, multi-source, and temporally inconsistent system data from all connected objects, can make the digital twin establishment inefficient, inaccurate, and/or outdated. Third, the finally formed optimization problem, which consists of a large number of connected objects and their associated attributes, will become overly complex and difficult, if not impossible, to solve with traditional mathematical techniques.

The utilization of the presently disclosed system and method for the construction of multi-layered digital twins in a complex system can help achieve low-complexity management of the smart grid. The management process begins by identifying the operational objectives of the smart grid. The operational objectives in such a system include optimizing overall grid performance by enhancing energy distribution, balancing load, and improving grid stability. Then, a series of steps to evaluate the system situation is conducted by analyzing the collected system data from different parts of the smart grid. Specific elements from the selected connected objects relevant to these operational objectives are prioritized for data collection, where an element is defined as one attribute of the corresponding connected object.

The DMS or EMS continuously monitor the complex smart grid by collecting system data from these prioritized elements. The system data could be reported through wireless networks or wired connections to DMS or EMS. This collected system data is processed to obtain KPI data, which represent the operational situations of the overall complex system or its subsystems. Relevant KPIs for the operational objectives in such a system might include energy efficiency, grid reliability, power quality, renewable energy utilization, and customer satisfaction level. The KPI data are dynamically obtained by methods such as analyzing system statistics, collecting reported KPI data, and model-based KPI prediction. By comparing the KPI data with the operational objectives, potential problematic subsystems are identified. For example, by comparing the current power quality and the optimal grid performance, a gap indicating potential areas of instability can be identified. Other gaps, including energy losses, transmission bottlenecks, or low renewable energy integration, are all potential problems in the complex smart grid needing efficient management strategies.

Upon identifying these problematic subsystems, the severity of unaccomplished or unsatisfied operational objectives is reported for further operation and optimization. Based on this evaluation, the multi-layered digital twin construction strategy is developed, prioritizing the creation of digital twins for problematic subsystems with severe problems. If the DMS or EMS identify that all operational objectives have been accomplished, they continue to monitor the complex smart grid by collecting system data from the connected objects. This continuous monitoring process ensures that the system can dynamically re-optimize the multi-layered digital twin architecture and operate the overall smart grid upon identifying new problems, thereby sustaining the satisfaction of the operational objectives of the complex smart grid.

With one or more unaccomplished operational objectives identified, the hierarchical multi-layered digital twin architecture is designed and adapted to be responsive to system situations and operational problems. The multi-layered digital twin architecture comprises one or more higher layers for system digital twins configured to model and manage one or more operational objectives of the system or subsystems, and one lowest layer constructing element digital twins or collecting system data from the connected objects based on guidance received from the higher layers, where each element digital twin represents the behavior of its respective connected object. Each digital twin layer is characterized by different scales, structures, functionalities, inputs, outputs, and modeling processes.

In the context of managing the smart grid using multi-layered digital twins, the functionalities of the higher layers include continuously evaluating the system situation, identifying problems such as energy imbalances or grid instability, analyzing the root causes of these problems, and making decisions for the operation of the system or subsystems. The lowest layer processes system data and conducts specific modeling for each selected connected object, like a renewable energy source or consumer identified by the higher layers.

The interactions between the layers of the multi-layered digital twin architecture in the smart grid are characterized by the lowest layer transmitting parameters of each element digital twin to the higher layers, such as energy consumption and renewable energy output. A higher layer transmits parameters of its subsystem digital twin, such as regional energy distributions, to even higher layers. A higher layer with a system digital twin transmits modeling guidance and operation commands for one subsystem, such as a substation, to another higher layer with the subsystem. A higher layer with a subsystem digital twin transmits modeling guidance and operation commands for the connected objects to guide the lowest layer, ensuring optimized operations across the entire smart grid.

The data gathering, data processing, and digital twin modeling processes are designed to be vertically integrated and dynamically adjusted based on system situations. System data from connected objects is processed at the DMS and EMS to establish element digital twins, which model specific elements such as energy usage and grid stability of individual buildings or energy sources. These element digital twins feed into the higher layers of the system digital twin, which evaluates the overall performance of the smart grid and identifies areas needing optimization.

The multi-layered digital twins are utilized to generate decisions and optimize system performance, thereby actively satisfying the operational objectives of the smart grid. This includes dynamically adjusting energy distribution, load balancing, and integrating renewable energy sources to enhance grid performance, balance supply and demand, and improve grid stability. Additionally, a human-in-the-loop digital twin structure can be developed to flexibly integrate autonomous operations and inputs from human operators. This structure enables a range of operation modes, including fully autonomous operation, human-guided operation, and integrated hybrid operation.

The system conditions are continuously monitored by repeating the system data collection and situation evaluation processes. Based on updated system data, the multi-layered digital twin architecture and system operation are re-optimized upon identification of new problems, ensuring sustained satisfaction of the operational objectives in the smart grid. This approach leverages the disclosed method to effectively manage and optimize the complex smart grid, ensuring high performance, balanced energy distribution, and improved grid stability for all consumers.

For illustrative purposes, the following example can be helpful in understanding association of KPI, measured data, objects and model parameters in a supply chain implementation of a multi-layered digital twin approach:

Operational Objective: Balance the load across the grid to prevent overloads and ensure efficient energy distribution.

### KPIs

Load Distribution Uniformity
Grid Stability (frequency and voltage consistency)
Energy Storage Utilization

### System Data to Measure

Real-time load data across different grid segments
Grid frequency and voltage levels
State of charge (SoC) of energy storage systems

### Sensing Components

Smart meters (for real-time load data)
Grid sensors (for frequency and voltage levels)
Battery management systems (for SoC of energy storage systems)

### Model Parameters of Element Digital Twins

Load demand coefficient, Transmission efficiency coefficient, and/or Machine learning model coefficients

### Connected Objects to be Controlled

Smart appliances (controllable loads)
Energy storage systems (batteries, pumped hydro)
Distributed generation units (solar panels, wind turbines)

### Actions to Improve System Performance

Adjust power usage of smart appliances based on real-time grid conditions
Optimize the use of energy storage systems
Integrate and coordinate distributed generation
Redistribute power flows

Further examples of a hierarchical multi-layered digital twin approach may be considered. An example is a computer-implemented method for digital twin construction in a complex system comprising a plurality of sensor modules communicative with a plurality of connected objects communicating with a communication network and reporting system data via the communication network to at least one server, the method comprising: identifying an operational objective of the complex system and a key performance indicator (KPI) associated with the operational objective; obtaining KPI data to measure performance of the complex system in terms of the operational objective, wherein the KPI data is associated with a timestamp and is dynamically obtained based on measured system data reported from the plurality of sensor modules, model-based KPI prediction, or a combination thereof; determining an unsatisfactory performance in the operational objective of the complex system based on a gap between the obtained KPI data to an expected baseline value or range to identify a problematic subsystem; generating a plurality of element digital twins based on measured system data from the plurality of sensor modules, each of the plurality of element digital twins including a model parameter to represent an attribute of at least one of the plurality of connected objects relevant to the identified problematic subsystem, the attribute being measured by at least one of the plurality of sensor modules, each of the plurality of element digital twins generating predicted system data based on the model parameter, the predicted system data associated with a timestamp; integrating the predicted system data, the model parameter, or both the predicted system data and the model parameter of at least a portion of the plurality of element digital twins to construct a system digital twin to receive and evaluate the predicted system data from the at least a portion of the plurality of element digital twins; generating an operational instruction from the system digital twin to change a configuration of the identified problematic subsystem to improve the unsatisfactory performance. In a further related example, the expected baseline value or range is a predetermined threshold value expected to accomplish the operational objectives, and the determination of unsatisfactory performance occurs when the KPI data fails to meet the predetermined threshold value. In a further related example, the method further comprises: determining a remaining unsatisfactory performance in the operational objective of the complex system based on a remaining gap between the obtained KPI data to an expected baseline value or range to identify a remaining problematic portion of the identified problematic subsystem; updating the plurality of element digital twins; updating the system digital twin; generating an operational instruction from the updated system digital twin to change a configuration of the identified problematic subsystem to improve the remaining unsatisfactory performance. In a further related example, the system digital twin comprises at least a first system digital twin for the complex system and a second system digital twin for the problematic subsystem, the operational objective is a plurality of operational objectives, and the number of system digital twins is positively correlated to the number of operational objectives exhibiting unsatisfactory performance. In a further related example, each unsatisfactory performance is evaluated by at least one of the system digital twins. In a further related example, the method further comprises: converting timestamps associated with the measured system data or the predicted system data to a unified compatible format; and adjusting time error in the measured system data or predicted system data to generate synchronized data; and resampling the synchronized data. In a further related example, the time error can be determined by comparing a local clock embedded in each of the plurality of relevant connected objects with a reference clock. In a further related example, the method further comprises: determining an expected contribution of each of the plurality of relevant connected objects to improving the unsatisfactory performance in the operational objective based on the attribute and associated attribute data pattern of each of the plurality of connected objects; prioritizing the plurality of relevant connected objects according to the expected contribution to identify a set of prioritized relevant connected objects as a subset of the plurality of relevant connected objects; configuring the set of prioritized relevant connected objects with a greater data sampling resolution, a greater data sampling rate, a greater reporting frequency, or any combination thereof, compared to each of the plurality of relevant connected objects excluded from the set of prioritized relevant connected objects. In a further related example, the set of prioritized connected objects is a plurality of sets of prioritized connected objects, including a first prioritized set and a second prioritized set, the first prioritized set and the second prioritized set are non-overlapping and are assigned a different priority such that the first prioritized set is configured with a greater data sampling resolution, a greater data sampling rate, a greater reporting frequency, or any combination thereof, compared to each member of the second prioritized set. In a further related example, the model parameters are variables within a mathematical, statistical, or computational model that define characteristics of the element digital twins and include at least one of machine learning model coefficients, regression coefficients, hyperparameters, material properties, weighting coefficients, or environmental factors.

Embodiments disclosed herein, or portions thereof, can be implemented by programming one or more computer systems or devices with computer-executable instructions embodied in a non-transitory computer-readable medium. When executed by a processor, these instructions operate to cause these computer systems and devices to perform one or more functions particular to embodiments disclosed herein. Programming techniques, computer languages, devices, and computer-readable media necessary to accomplish this are known in the art.

In an example, a non-transitory computer readable medium embodying a computer program for digital twin construction in a complex system may comprise: computer program code for evaluating a KPI data within the system data reported from the plurality of connected objects, the KPI data relevant to an operational objective of the complex system; computer program code for determining an insufficient/unsatisfactory performance in the operational objective of the complex system based on comparing KPI data to an expected baseline value or range; computer program code for generating a plurality of element digital twins based on measured system data from the plurality of sensor modules, each of the plurality of element digital twins including a model parameter to represent an attribute of at least one of the plurality of connected objects relevant to the identified problematic subsystem, the attribute being measured by at least one of the plurality of sensor modules, each of the plurality of element digital twins generating predicted system data based on the model parameter, the predicted system data associated with a timestamp; computer program code for integrating the predicted system data, the model parameter, or both the predicted system data and the model parameter of at least a portion of the plurality of element digital twins to construct a system digital twin to receive and evaluate the predicted system data from the at least a portion of the plurality of element digital twins; computer program code for generating an operational instruction from the system digital twin to change a configuration of the identified problematic subsystem to improve the unsatisfactory performance.

The computer readable medium is a data storage device that can store data, which can thereafter, be read by a computer system. Examples of a computer readable medium include read-only memory, random-access memory, CD-ROMs, magnetic tape, optical data storage and the like. The computer readable medium may be geographically localized or distributed over a computer network system so that computer readable code is stored and executed in a distributed fashion.

Computer-implementation of the system or method typically comprises a memory, an interface and a processor. The types and arrangements of memory, interface and processor may be varied according to implementations. For example, the interface may include a software interface that communicates with an end-user computing device through an Internet connection. The interface may also include a physical electronic device configured to receive requests or queries from a device sending digital and/or analog information. In other examples, the interface can include a physical electronic device configured to receive signals and/or data relating to an operational objective of the currently disclosed method and system, for example from a connected object incorporating a sensor module and a clock.

Any suitable processor type may be used depending on a specific implementation, including for example, a microprocessor, a programmable logic controller or a field programmable logic array. Moreover, any conventional computer architecture may be used for computer-implementation of the system or method including for example a memory, a mass storage device, a processor (CPU), a graphical processing unit (GPU), a Read-Only Memory (ROM), and a Random-Access Memory (RAM) generally connected to a system bus of data-processing apparatus. Memory can be implemented as a ROM, RAM, a combination thereof, or simply a general memory unit. Software modules in the form of routines and/or subroutines for carrying out features of the system or method can be stored within memory and then retrieved and processed via processor to perform a particular task or function. Similarly, one or more method steps may be encoded as a program component, stored as executable instructions within memory and then retrieved and processed via a processor. A user input device, such as a keyboard, mouse, or another pointing device, can be connected to PCI (Peripheral Component Interconnect) bus. If desired, the software may provide an environment that represents programs, files, options, and so forth by means of graphically displayed icons, menus, and dialog boxes on a computer monitor screen. For example, any number of system data acquired from a sensor module incorporated in a connected object and any number of digital twin prediction or simulation results may be displayed, including for example a plot of a time-series of synchronized KPI data relevant to an operational objective, or for example, a predicted or simulated behavior of a problematic subsystem.

Computer-implementation of the system or method may accommodate any type of end-user computing device including computing devices communicating over a networked connection. The computing device may display graphical interface elements for performing the various functions of the system or method, including for example display of results of a prediction or simulation executed by a digital twin. For example, the computing device may be a server, desktop, laptop, notebook, tablet, personal digital assistant (PDA), PDA phone or smartphone, and the like. The computing device may be implemented using any appropriate combination of hardware and/or software configured for wired and/or wireless communication. Communication can occur over a network, for example, where remote control of the system is desired. Computing devices, such as one or more servers connected to a communication network in supporting operation of the method or system, may be arranged in any suitable geographically localized or distributed manner, while maintaining adequate monitoring and evaluation by a hierarchical multi-layered digital twin architecture such that the operation can be either centralized, decentralized, or hybrid of centralized and decentralized as desired.

If a networked connection is desired, the system or method may accommodate any type of network. The network may be a single network or a combination of multiple networks. For example, the network may include the Internet and/or one or more Intranets, landline networks, wireless networks, local area networks and/or other appropriate types of communication networks. In another example, the network may comprise a wireless telecommunications network (e.g., cellular network) adapted to communicate with other communication networks, such as the Internet. For example, the network may comprise a computer network that makes use of a TCP/IP protocol (including protocols based on TCP/IP protocol, such as HTTP, SMTP or FTP).

Embodiments described herein are intended for illustrative purposes without any intended loss of generality. Still further variants, modifications and combinations thereof are contemplated and will be recognized by the person of skill in the art. Accordingly, the foregoing detailed description is not intended to limit scope, applicability, or configuration of claimed subject matter.

1. A computer-implemented method for digital twin construction in a complex system comprising a plurality of sensor modules communicative with a plurality of connected objects communicating with a communication network and reporting system data via the communication network to at least one server, the method comprising:
identifying an operational objective of the complex system and a key performance indicator (KPI) associated with the operational objective;
obtaining KPI data to measure performance of the complex system in terms of the operational objective, wherein the KPI data is associated with a timestamp and is dynamically obtained based on measured system data reported from the plurality of sensor modules, model-based KPI prediction, or a combination thereof;
determining an unsatisfactory performance in the operational objective of the complex system based on a gap between the obtained KPI data to an expected baseline value or range to identify a problematic subsystem;
generating a plurality of element digital twins based on measured system data from the plurality of sensor modules, each of the plurality of element digital twins including a model parameter to represent an attribute of at least one of the plurality of connected objects relevant to the identified problematic subsystem, the attribute being measured by at least one of the plurality of sensor modules, each of the plurality of element digital twins generating predicted system data based on the model parameter, the predicted system data associated with a timestamp;
integrating the predicted system data, the model parameter, or both the predicted system data and the model parameter of at least a portion of the plurality of element digital twins to construct a system digital twin to receive and evaluate the predicted system data from the at least a portion of the plurality of element digital twins; and
generating an operational instruction from the system digital twin to change a configuration of the identified problematic subsystem to improve the unsatisfactory performance.

2. The method of claim 1, wherein the expected baseline value or range is a predetermined threshold value expected to accomplish the operational objectives, and the determination of unsatisfactory performance occurs when the KPI data fails to meet the predetermined threshold value.

3. The method of claim 1, further comprising:
determining a remaining unsatisfactory performance in the operational objective of the complex system based on a remaining gap between the obtained KPI data to an expected baseline value or range to identify a remaining problematic portion of the identified problematic subsystem;
updating the plurality of element digital twins;
updating the system digital twin; and
generating an operational instruction from the updated system digital twin to change a configuration of the identified problematic subsystem to improve the remaining unsatisfactory performance.

4. The method of claim 1, wherein the system digital twin comprises at least a first system digital twin for the complex system and a second system digital twin for the problematic subsystem, the operational objective is a plurality of operational objectives, and the number of system digital twins is positively correlated to the number of operational objectives exhibiting unsatisfactory performance.

5. The method of claim 4, wherein each unsatisfactory performance is evaluated by at least one of the system digital twins.

6. The method of claim 1, further comprising
converting timestamps associated with the measured system data or the predicted system data to a unified compatible format; and
adjusting time error in the measured system data or predicted system data to generate synchronized data; and
resampling the synchronized data.

7. The method of claim 6, wherein the time error can be determined by comparing a local clock embedded in each of the plurality of relevant connected objects with a reference clock.

8. The method of claim 1, further comprising
determining an expected contribution of each of the plurality of relevant connected objects to improving the unsatisfactory performance in the operational objective based on the attribute and associated attribute data pattern of each of the plurality of connected objects;
prioritizing the plurality of relevant connected objects according to the expected contribution to identify a set of prioritized relevant connected objects as a subset of the plurality of relevant connected objects; and
configuring the set of prioritized relevant connected objects with a greater data sampling resolution, a greater data sampling rate, a greater reporting frequency, or any combination thereof, compared to each of the plurality of relevant connected objects excluded from the set of prioritized relevant connected objects.

9. The method of claim 8, wherein the set of prioritized connected objects is a plurality of sets of prioritized connected objects, including a first prioritized set and a second prioritized set, the first prioritized set and the second prioritized set are non-overlapping and are assigned a different priority such that the first prioritized set is configured with a greater data sampling resolution, a greater data sampling rate, a greater reporting frequency, or any combination thereof, compared to each member of the second prioritized set.

10. The method of claim 1, wherein the model parameters are variables within a mathematical, statistical, or computational model that define characteristics of the element digital twins and include at least one of machine learning model coefficients, regression coefficients, hyperparameters, material properties, weighting coefficients, or environmental factors.

11. The method of claim 1 implemented in a telecommunications network, wherein:
the operational objective is to enhance network capacity;
the KPI include at least one of network capacity, coverage area, or user experience;
the measured system data is traffic load data measured by base station sensors, signal strength data or signal quality data measured by an RF module in user devices, and user mobility pattern data measured by a GPS sensor in the user devices;
the model parameters of element digital twins include at least one of transmission power, path loss coefficient, or machine learning model coefficients;
the connected objects are user devices and interference mitigation devices; and
the operational instruction from the system digital twin is to execute at least one of dynamic resource allocation on the base stations, redistributing traffic loads across network areas or segments to avoid congestion, or implementing interference cancellation techniques.

12. The method of claim 11, wherein the interference mitigation devices include a filter or smart antenna embedded in a base stations or user devices.

13. The method of claim 1 implemented in a smart grid, wherein:
the operational objective is to balance load across the smart grid to prevent overloads and achieve efficient energy distribution,
the KPI include at least one of load distribution uniformity, grid stability, or energy storage utilization,
the measured system data is real-time load data across different grid segments measured by smart meters, grid frequency and voltage levels measured by grid sensors; and state of charge (SoC) of energy storage systems measured by battery management systems;
the model parameters of element digital twins include at least one of load demand coefficient, transmission efficiency coefficient, or machine learning model coefficients;
the connected objects are smart appliances, energy storage systems, and distributed power generation units; and
the operational instruction from the system digital twin is to execute at least one of adjusting power usage of smart appliances based on real-time grid conditions, adjusting use of energy storage systems, integrating and coordinating distributed generation, or redistributing power flows.

14. The method of claim 13, wherein the energy storage systems include a battery or a pumped hydro energy storage, and the distributed power generation unit include a solar panel or a wind turbine.

15. The method of claim 1 implemented in a supply chain, wherein:
the operational objective is to enhance efficiency and reliability of operations;
the KPI include at least one of order fulfillment rate, delivery lead time, or inventory accuracy;
the measured system data is order status and fulfillment data measured by order management systems, transit times and shipping durations measured by GPS trackers, and inventory levels and discrepancies measured by inventory sensors;
the model parameters of element digital twins include at least one of transportation efficiency coefficient, or machine learning model coefficients;
the connected objects are order processing systems, transportation vehicles, warehouse storage systems; and
the operational instruction from the system digital twin is to execute at least one of adjusting order processing workflows by streamlining order entry, picking, and packing processes, enhancing transportation planning by planning and adjusting transportation routes, schedules, and methods to minimize delays and reduce costs, or improving inventory management practices by implementing automated inventory updates to enhance accuracy and reduce discrepancies.

16. The method of claim 15, wherein the order processing systems include an enterprise resource planning (ERP) systems, the transportation vehicles include a truck, a ship, or a plane, the warehouse storage systems include a racking system, or an automated storage and retrieval system.

17. A system for executing the method of claim 1, wherein the system comprises:
a memory for storing the KPI data, the measured system data, the predicted system data, and the model parameters;
each of the plurality of connected objects linked to the communication network;
each of the plurality of sensors including a clock and linked to the communication network; and
at least one server connected to the communication network in supporting the operation of the system and executing the method of claim 1.

18. The system of claim 17, wherein the communication network is the Internet.

19. A non-transitory computer readable medium embodying computer readable code for executing the method of claim 1, the computer readable medium comprising:
computer program code for obtaining KPI data to measure performance of the complex system in terms of the operational objective, wherein the KPI data is associated with a timestamp and is dynamically obtained based on measured system data reported from the plurality of sensor modules, model-based KPI prediction, or a combination thereof,
computer program code for determining an unsatisfactory performance in the operational objective of the complex system based on a gap between the obtained KPI data to an expected baseline value or range to identify a problematic subsystem;
computer program code for generating a plurality of element digital twins based on measured system data from the plurality of sensor modules, each of the plurality of element digital twins including a model parameter to represent an attribute of at least one of the plurality of connected objects relevant to the identified problematic subsystem, the attribute being measured by at least one of the plurality of sensor modules, each of the plurality of element digital twins generating predicted system data based on the model parameter, the predicted system data associated with a timestamp;
computer program code for integrating the predicted system data, the model parameter, or both the predicted system data and the model parameter of at least a portion of the plurality of element digital twins to construct a system digital twin to receive and evaluate the predicted system data from the at least a portion of the plurality of element digital twins; and
computer program code for generating an operational instruction from the system digital twin to change a configuration of the identified problematic subsystem to improve the unsatisfactory performance.

20. The computer readable media of claim 19, wherein the communication network is the Internet.

21.-44. (canceled)
